(19) United States
(12) Patent Application Publication
(10) Pub. No.: US 2025/0306912 A1
(43) Pub. Date: Oct. 2, 2025

(54) IMPROVED FIRMWARE UPDATE WITH REDUCED IMPACT FOR WORKFLOW APPLICATIONS

(71) Applicant: MICROSOFT TECHNOLOGY LICENSING, LLC, Redmond, WA (US)

(72) Inventors: Nagasubramanian GURUMOORTHY, Leander, TX (US); Ankur GARG, Redmond, WA (US); Karunakara KOTARY, Redmond, WA (US); Venkatesh RAMAMURTHY, Redmond, WA (US)

(21) Appl. No.: 18/622,634

(22) Filed: Mar. 29, 2024

(51) Int. Cl. G06F 8/656; G06F 9/48

(52) U.S. Cl. CPC G06F 8/656; G06F 9/485

(57) ABSTRACT

Various embodiments described herein dynamically coordinate graphics processing unit (GPU) execution of a workflow with installation of a firmware update by controlling the workflow to pause execution of the workflow, capturing a snapshot of content of a workflow application associated with the workflow, and continuing execution of the workflow based on the snapshot and after an aspect of the firmware update has been installed on the GPU. To minimize the disruption to a cluster or a node, certain embodiments cause the firmware update to be pushed to primary GPUs of primary nodes. These primary GPUs then communicate the firmware update to neighboring GPUs to cause neighboring GPUs to perform the firmware update, for example, in parallel. In this manner, certain embodiments facilitate the quicker parallel execution of the firmware update across GPUs in a data center, while coordinating the execution with workflows being executed on the GPUs.

### BACKGROUND

Performing computations, workflows, workloads, or tasks in a distributed environment, such as a “cloud computing system” or the “cloud,” generally represents a transformative paradigm in computing that leverages the power of remote data centers to perform complex computing tasks. An example of complex computing workflows or tasks include those associated with artificial intelligence (AI). Accessibility to AI has been facilitated by the widespread adoption of the cloud, which has evolved in response to the increasing demand for computational resources that exceed the computational resources available on individual devices running locally on-premises. Recent widespread adoption of AI has caused the demand for computational resources provided by certain distributed environments to increase. For example, running AI-based operations includes processing raw data, initializing AI models, iteratively training the AI models, validating the AI models, deploying the trained and validated AI models, and processing user requests made against these deployed AI models.

In some instances, the computational demands associated with efficiently performing these AI-based operations have quickly evolved, which has caused certain existing distributed environments to grow outdated as the capabilities of these distributed environments become outpaced by AI. One way to improve computational efficiency of certain distributed environments includes pushing firmware updates to certain components of the distributed environment, which may disrupt the execution of workflows, cause computational delays, make certain cloud computational resources temporarily unavailable, or result in delays or other customer interruptions.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein coordinate execution of a workflow with a firmware update. In particular, certain embodiments coordinate the execution of a workflow executed by an accelerator (for example, graphics processing units [GPUs]) with a firmware update also scheduled to be executed on the same accelerator. Typically, performing the firmware update on a GPU in a data center causes the GPU to stop executing the workflow, go offline to install the firmware update, and be inaccessible to execute the workflow for the client, thereby resulting in data center downtime and delayed execution of the workflow. To make matters worse, in certain existing approaches, causing a GPU to perform a firmware update in between execution of the workflow causes progress through the workflow to be lost. As a result of this loss, the GPU has to restart execution of the workflow from the beginning, thereby causing computational resources to be expended in performing aspects of the workflow that were already performed, all in an effort to recover loss of workflow content due to implementing the firmware update.

To improve performing firmware updates on an accelerator (also referred to as “coprocessors” in one example), such as a GPU, certain embodiments control a workflow application running the workflow and capture a snapshot of content associated with the workflow before proceeding with performing a firmware update. Indeed, certain embodiments perform the firmware update subsequent to the snapshot being captured and the workflow application being controlled. To minimize the disruption to a cluster or a node, certain embodiments cause the firmware update to only be pushed to primary GPUs of primary nodes. These primary GPUs can communicate the firmware update to neighboring GPUs to cause neighboring GPUs to perform the firmware update, for example, in parallel. In this manner, a firmware orchestrator does not have to communicate with each node or each GPU to cause the firmware update to be serially implemented. Instead, certain embodiments facilitate the quicker parallel execution of the firmware update across GPUs in a data center by leveraging primary GPUs and the electrical connections to other neighboring GPUs.

In some embodiments, functionality is divided between application layer components and operating system components of the GPU or other components of a node. However, this division is provided to help illustrate one embodiment and is not intended to limit this disclosure because the embodiments described herein can be implemented via any suitable abstraction layer of hardware components. For example, the firmware application interface of the GPU accesses a request to perform a firmware update. In this example, the GPU makes the firmware update available, via the firmware application interface, to a coordinator operating system (OS) driver of the GPU. By making the firmware update available to the coordinator OS driver, the example GPU causes the coordinator OS driver to control a workflow application being hosted or executed on the at least one GPU. In some embodiments, the coordinator OS driver causes the workflow application to pause and save content associated with the workflow to a high-bandwidth memory (HBM) of the GPU. For example, the GPU captures a snapshot of content stored on the GPU. Embodiments of the GPU perform the firmware update subsequent to the workflow application being controlled and the snapshot being captured. Subsequent to completion of the firmware update, embodiments of the GPU cause the coordinator OS driver to resume the execution of the workflow application based at least on the snapshot. For example, the GPU can resume performing the workflow associated with the workflow application from the snapshot of content stored on the HBM.

The present disclosure provides one or more technical solutions that have technical effects in light of various technical problems, Various embodiments discussed herein provide efficient implementation of firmware updates on GPUs in a data center, while reducing disruption to workflows associated with certain workflow application. For example, by employing certain embodiments, a workflow is paused, a snapshot of content of the paused workflow is captured, and the snapshot is used to continue executing the workflow after the firmware update has been implemented by the GPU. To efficiently use clock cycles, the GPU performs the firmware update between the time the workflow is paused and the time the workflow is commenced. By checking if a firmware needs to be implemented, certain embodiments ensure that hardware in data centers remains up-to-date with the latest software patches to improve the lifespan and operation, as well as to reduce the wear and tear experienced by hardware components. Additionally, certain embodiments have the technical effect of increasing scalability, allowing computing systems to implement the firmware update in parallel across dozens, hundreds, thousands, or even millions of GPUs or nodes, for example, by initially pushing the firmware update to primary nodes or primary GPUs that then communicate the firmware to neighboring nodes or GPUs.

### BRIEF DESCRIPTION OF THE DRAWINGS

The present disclosure is described in detail below with reference to the attached drawing figures, wherein:

FIG. 1 is a block diagram of an example operating environment suitable for implementations of the present disclosure;

FIG. 2A is a block diagram of an example system including a node having discrete accelerators, in accordance with an embodiment of the present disclosure;

FIG. 2B is a block diagram of an example system including a node having a uniform baseboard (UBB) containing discrete accelerators, in accordance with an embodiment of the present disclosure;

FIG. 3A is a block diagram of an example system including a node having a motherboard (MB) baseboard management controller (BMC) configured to control installation of a firmware update, in accordance with an embodiment of the present disclosure;

FIG. 3B is a block diagram of an example system including a node having a host agent configured to control installation of a firmware update, in accordance with an embodiment of the present disclosure;

FIG. 4A is a block diagram of an example system including a node having at least one accelerator that coordinates installation of a firmware update with a workflow, in accordance with an embodiment of the present disclosure;

FIG. 4B is a block diagram of an example system including a node having at least one accelerator that coordinates installation of a firmware update with a workflow, in accordance with an embodiment of the present disclosure;

FIG. 5A is a block diagram of an example system including a data center orchestrator communicatively coupled to a rack of nodes, in accordance with an embodiment of the present disclosure;

FIG. 5B is a block diagram of an example system including a data center orchestrator communicatively coupled to a primary node, which is communicatively coupled to a plurality of secondary nodes, in accordance with an embodiment of the present disclosure;

FIG. 6A is a block diagram of an example system including a node in which performing a workflow is coordinated with performing a firmware update, in accordance with an embodiment of the present disclosure;

FIG. 6B is a block diagram of an example system including a node in which performing a workflow is coordinated with performing a firmware update, in accordance with an embodiment of the present disclosure;

FIG. 7A is a flow diagram of the interaction of computing components to coordinate performing a workflow with performing a firmware update, in accordance with an embodiment of the present disclosure;

FIG. 7B is a flow diagram of the interaction of computing components to coordinate performing a workflow with a firmware update, in accordance with an embodiment of the present disclosure;

FIG. 8 depicts a flow diagram of a first method for coordinating the execution of a workflow with the performance of a firmware update with reduced impact to the workflow, in accordance with an embodiment of the present disclosure;

FIG. 9 depicts a flow diagram of a second method for coordinating the execution of a workflow with the performance of a firmware update with reduced impact to the workflow, in accordance with an embodiment of the present disclosure;

FIG. 10 depicts a flow diagram of a third method for coordinating the execution of a workflow with the performance of a firmware update with reduced impact to the workflow, in accordance with an embodiment of the present disclosure;

FIG. 11 is a block diagram of an example computing device suitable for use in implementing an embodiment of the present disclosure; and

FIG. 12 is a block diagram of an example computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Embodiments of the technology described herein dynamically coordinate graphics processing unit (GPU) execution of a workflow with a firmware update by controlling the workflow to pause execution of the workflow, taking a snapshot of content of a workflow application associated with the workflow, and continuing execution of the workflow based on the snapshot and after an aspect of the firmware update has been installed on the GPU.

In one example, a “workflow” (also referred to herein in one example as “tasks” or “workload”) refers to a series or collection of activities or computations associated with completing a task. In one example, a “workflow” is also referred to as a “task” or “set of tasks.” An example AI-based workflow includes aspects of raw data processing, featurization, training, inference, and deployment. In some embodiments, the workflow from user accounts is classified based on the job type and the deployment type. In one example, the job type refers to the task classification and includes any suitable classification such as “basic,” “standard,” and/or “premium,” as defined by a service-level agreement (SLA).

In one example, a “snapshot” of content for a workflow refers to a point-in-time representation of data or information within the workflow associated with a workflow application. An example snapshot captures the current state of a document, structures, data, computations, tasks, or other elements involved in the workflow. The workflow application can store a copy of the snapshot on a memory device (high-bandwidth memory) of the GPU. The snapshot may include metadata associated with the execution of the workflow application or contextual data associated with the execution of the workflow application. In some embodiments, the snapshot is accessed by embodiments of the GPU to track progress, review details, or continue execution of the workflow at the point-in-time representation of the snapshot of the workflow. In this manner, a workflow can be continued from the point-in-time representation of the data associated with the workflow at a later time (for example, after performing an aspect of the firmware update) without having to restart due to installing a firmware update.

In one example, a “firmware update” includes updating one or more patches of software embedded or running on hardware components. In the context of certain accelerators or processors, such as GPUs, the firmware update is responsible for improving performance, fixing bugs, enhancing compatibility with other software or hardware components, and supporting new features. Indeed, certain firmware updates reconfigure software that is embedded or running on the GPU to better ensure that the GPU is well-equipped for technological advances with software and computing, such as those associated with the quickly evolving field of AI.

More recently, the rapid evolution of AI has resulted in certain complexities which have tried to be addressed through hardware-level reconfiguration of GPU, which has resulted in multiple design variants. To further keep up with the rapid evolution of AI, these GPUs can be updated with firmware aimed at ensuring up-to-date software that facilitates power efficiency, performance efficiency, and security. However, currently these firmware updates cause extensive disruptions to workflows being executed by these GPUs. For example, firmware updates performed on nodes having certain GPUs, such as NVIDIA® and AMD® GPUs, result in the corresponding nodes being offline and unable to execute a workflow for at least one hour per node. With hundreds, thousands, or millions of GPUs operating in Hyper scalar data centers requiring a minimum of two yearly updates—in some instances, several million hours of accumulated downtime is needed for servicing the firmware updates.

Certain challenges exist in the context of reducing impact to workflows when firmware updates are performed by the GPUs executing those workflows. For example, one challenge is that certain GPUs process and store large quantities (for example, several gigabytes [GBs]) of intermediate results in internal memory like high-bandwidth memory (HBM), graphics double data rate (GDDR), or any other memory device. Performing a firmware update may require a GPU-level reset to perform the firmware update, making it challenging to preserve contents stored in HMB or GDDR across resets. Another challenge is that GPU's internal memory, such as the HBM, can be remotely accessed from other GPUs in a same node or in other nodes in the cluster. As a result, dependencies between nodes in a cluster provide additional challenges.

To minimize the disruption to a cluster or a node, certain embodiments leverage hardware connections between the nodes and GPUs to cause the firmware update to be pushed to primary GPUs of primary nodes, for example, in a clustered manner. For example, certain clusters include hundreds, thousands, or any number of nodes that are interconnected to form a supercomputer. In one example, a “primary node” refers to a node that is directly coupled to a firmware orchestrator that receives the firmware update. In some embodiments, the primary node is classified differently (for example, as a “primary node”) than other nodes in a cluster. Embodiments of the firmware orchestrator perform a query to identify the primary node(s) based on the classification of the nodes. Thereafter, in some embodiments, the firmware orchestrator pushes the firmware update to the primary node or the primary node pulls the firmware update from the firmware orchestrator. In some embodiments, the firmware orchestrator only communicates the firmware update directly to certain GPUs of the primary node. These primary GPUs then communicate the firmware update to neighboring GPUs to cause neighboring GPUs to perform the firmware update, for example, in parallel. In this manner, certain embodiments facilitate the quicker parallel execution of the firmware update across GPUs in a data center, while coordinating the execution with workflows being executed on the GPUs.

To further reduce disruption to workflows running on GPUs on which a firmware update is being performed, certain embodiments pause execution of a workflow and capture a snapshot of content, associated with the workflow, that is stored on the HBM. In more detail, certain embodiments access a request to perform the firmware update associated with at least one graphics processing unit (GPU) of a node. Based on the request, certain embodiments cause a coordinator operating system (OS) driver of the at least one GPU to control a workflow application being hosted or executed on the at least one GPU, for example, by pausing execution of the workflow. In one example, the “coordinator OS driver” refers to a software component that enables communication between the OS (for example, of the GPU) and other abstraction layers of a hardware device, such as various applications. For example, the coordinator OS driver allows the OS to control and interact with various components of a hardware device. In one example, the coordinator OS driver translates high-level OS commands into instructions that hardware can understand.

Additionally, certain embodiments capture a snapshot of content stored on a high-bandwidth memory (HBM) associated with the GPU. After the snapshot is captured for the paused workflow application, certain embodiments perform the firmware update. Performing the firmware update may include performing one aspect of the firmware update, such that performing all aspects of the firmware update results in the firmware update being complete. In one example, the firmware update is performed over a series of smaller steps or smaller intervals to minimize disruption to the workflow. In another example, the firmware update is performed in one time interval, such as after the workflow is paused and the snapshot is captured. In some embodiments, performing the firmware update includes powering off and restarting the GPU on which the firmware update is performed. Certain embodiments cause the OS driver to resume the execution of the workflow application based at least on the snapshot and subsequent to completion of the firmware update. In this manner, the workflow can continue from the point in time during which the snapshot was captured and/or the workflow execution was paused.

Particular embodiments have the technical effect of improved lifespan and operation of hardware components in data centers, for example. This is because certain embodiments install firmware updates to maintain software patches running on GPUs current in light of advancements in technology. For example, certain firmware updates include up-to-date software patches that facilitate power efficiency, performance efficiency, and security. In this manner, particular embodiments facilitate long-term performance of GPUs so that data centers can continuously perform customer workflows.

Certain embodiments have the technical effect of controlling accelerators to achieve compliance with regional or organizational policy regulations. Certain providers of cloud computing services have data centers across different regions of the world, each with different regulations and rules surrounding the use of power. By employing certain embodiments disclosed herein, cloud computing service providers can comply with regional regulations by installing firmware updates that improve compliance. This dual benefit of compliance with a policy regulation while ensuring quality of service of workflows is difficult if not impossible to achieve absent the embodiments disclosed herein.

Various embodiments discussed herein provide efficient implementation of firmware updates on GPUs in a data center, while reducing disruption to workflows associated with a certain workflow application. By employing certain embodiments, a workflow is paused, a snapshot of content of the paused workflow is captured, and the snapshot is used to continue executing the workflow after the firmware update has been implemented by the GPU. For example, after a GPU performs an aspect of the firmware update, the GPU accesses data associated with the snapshot stored on the memory device and the workflow is continued from the point in time during which the snapshot was captured. In one embodiment, using the snapshot includes reading code (for example, binary or code in any format) associated with the snapshot and executing the code associated with the snapshot to restore progress in executing the workflow to the point in time during which the snapshot was captured.

To efficiently use clock cycles, the GPU performs the firmware update between the time the workflow is paused and the time the workflow is commenced. By checking if a firmware needs to be implemented, certain embodiments ensure that hardware in data centers remains up-to-date with the latest software patches to improve the lifespan and operation, as well as to reduce the wear and tear experienced by overprovisioned GPUs.

Additionally, certain embodiments have the technical effect of increasing scalability, allowing computing systems to implement the firmware update in parallel across dozens, hundreds, thousands, or even millions of GPUs or nodes, for example, by initially pushing the firmware update to primary nodes or primary GPUs that then communicate the firmware to neighboring nodes or GPUs. As discussed herein, certain embodiments identify the nodes that have been tagged as primary nodes to push the firmware update to nodes classified as primary nodes. Thereafter, certain primary nodes can communicate the firmware update to neighboring nodes for execution. Accordingly, instead of serially implementing firmware updates, certain embodiments perform firmware updates in parallel to reduce workflow disruption and downtime, while increasing the speed of performing the firmware update across a plurality of nodes or GPUs. In this manner, performing firmware updates can be scaled and enforced across large-scale operations associated with one or more data centers.

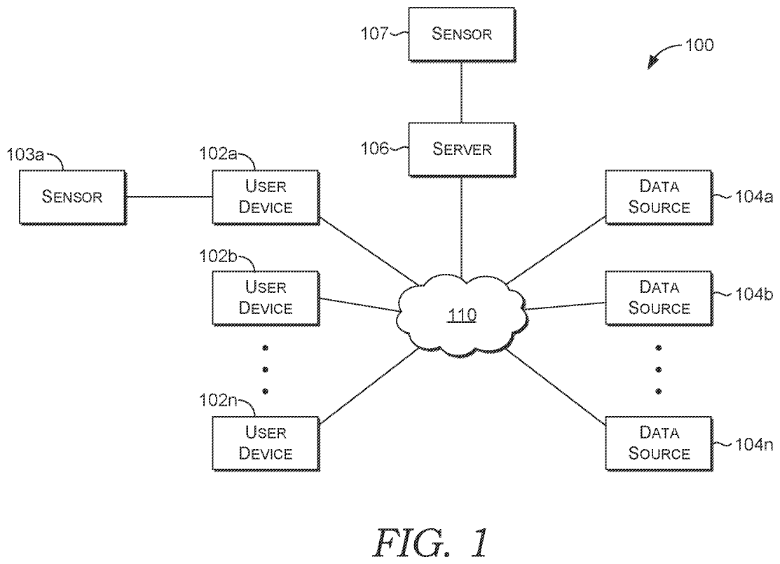

Turning now to FIG. 1, a block diagram is provided showing an example operating environment 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

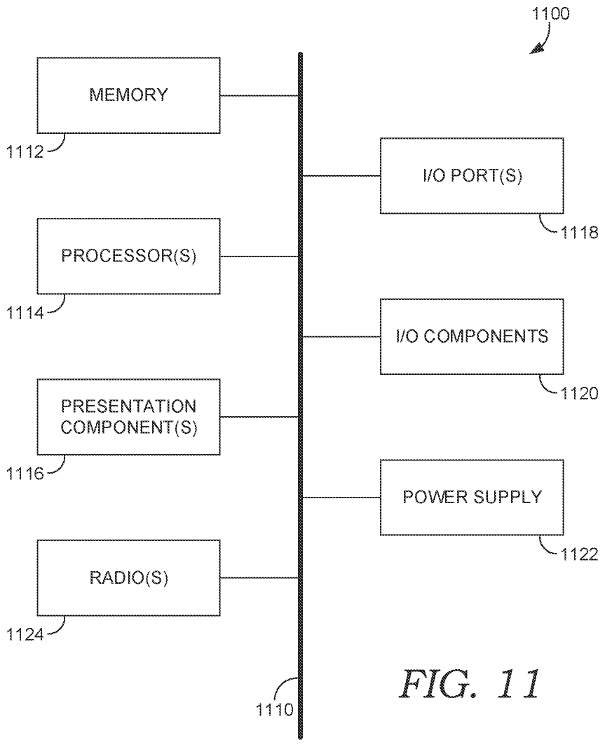

Among other components not shown, example operating environment 100 includes a number of user computing devices, such as user devices 102a and 102b through 102n; a number of data sources, such as data sources 104a and 104b through 104n; server 106; sensors 103a and 107; and network 110. It should be understood that operating environment 100 shown in FIG. 1 is an example of one suitable operating environment. Each of the components shown in FIG. 1 is implemented via any type of computing device, such as computing device 1100 illustrated in FIG. 11, for example. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

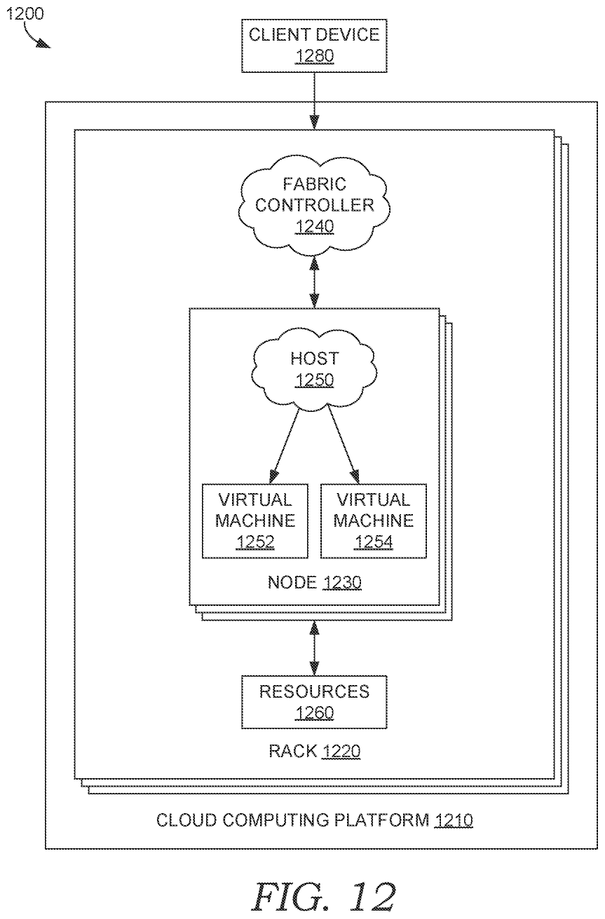

It should be understood that any number of user devices, servers, and data sources can be employed within operating environment 100 within the scope of the present disclosure. Each may comprise a single device or multiple devices cooperating in a distributed environment, such as the distributed computing environment 1200 in FIG. 12. For instance, server 106 is provided via multiple devices arranged in a distributed environment that collectively provides the functionality described herein. Additionally, other components not shown may also be included within the distributed environment.

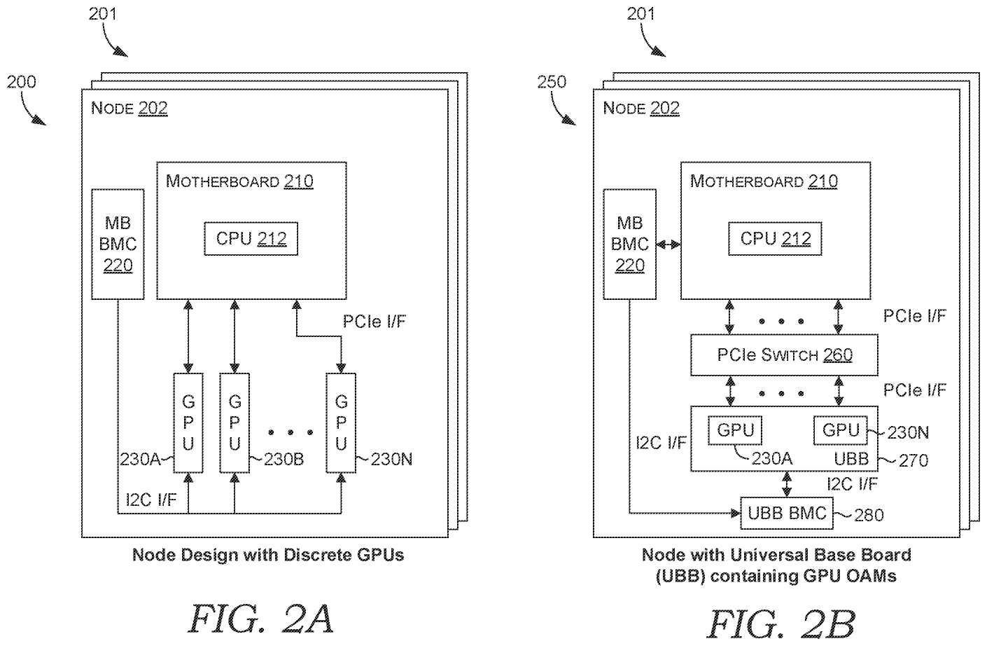

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. For example, user device 102a associated with a user account can communicate workflows over network 110 to the server 106 for processing consistent with the corresponding SLA. This division of operating environment 100 is provided to illustrate one example of a suitable environment, and there is no requirement for each implementation that any combination of server 106 and user devices 102a and 102b through 102n remain as separate entities. In one embodiment, the server 106 includes certain components of systems 200, 250, 300, 350, 400, 450, 500, 530, 600, 650, 700, or 750 of FIGS. 2A, 2B, 3A, 3B, 4A, 4B, 5A, 5B, 6A, 6B, 7A, and 7B, respectively.

In some embodiments, user devices 102a and 102b through 102n comprise any type of computing device capable of use by a user. For example, in one embodiment, user devices 102a and 102b through 102n are the type of computing device 1100 described in relation to FIG. 11. By way of example and not limitation, a user device is embodied as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an MP3 player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

In some embodiments, data sources 104a and 104b through 104n comprise data sources and/or data systems, which are configured to make data available to any of the various constituents of operating environment 100 or systems 200, 250, 300, 350, 400, 450, 500, 530, 600, 650, 700, or 750 of FIGS. 2A, 2B, 3A, 3B, 4A, 4B, 5A, 5B, 6A, 6B, 7A, and 7B, respectively. For instance, one or more data sources 104a and 104b through 104n provide (or make available for accessing) a firmware update and related software, a workflow application, user-specific activity data, and any other data disclosed herein. Certain data sources 104a and 104b through 104n are discrete from user devices 102a and 102b through 102n and server 106 or are incorporated and/or integrated into at least one of those components. In one embodiment, one or more of data sources 104a and 104b through 104n comprise one or more sensors, which are integrated into or are associated with one or more of the user device(s) 102a and 102b through 102n or server 106. Examples of data made available by data sources 104a and 104b through 104n can include a version of firmware, a firmware update, a workflow application and related functionality, GPU specifications, computer resource allocation parameters associated with a workflow, and any other data disclosed herein.

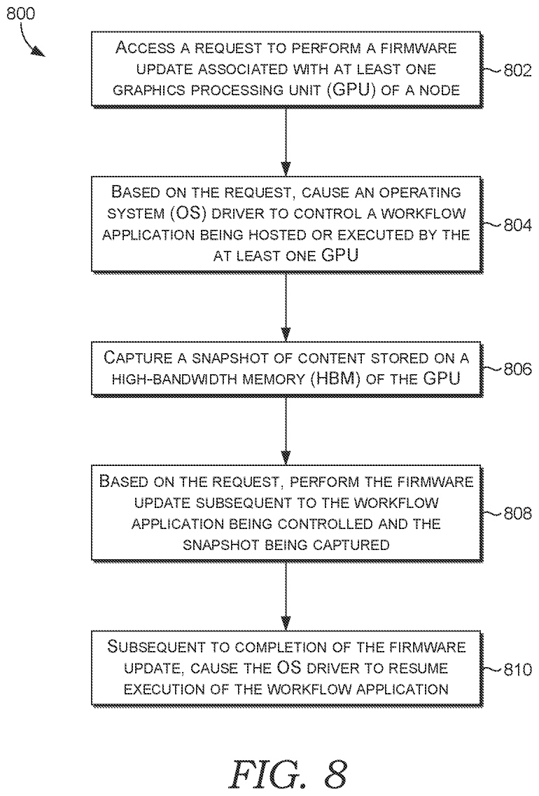

Operating environment 100 can be utilized to implement one or more of the components of systems 200, 250, 300, 350, 400, 450, 500, 530, 600, 650, 700, or 750 of FIGS. 2A, 2B, 3A, 3B, 4A, 4B, 5A, 5B, 6A, 6B, 7A, and 7B, respectively, to perform any suitable operations. Example operations include accessing a request to perform the firmware update associated with at least one graphics processing unit (GPU) of a node; causing an operating system (OS) driver of the at least one GPU to control a workflow application being hosted or executed on the at least one GPU; capturing a snapshot of content stored on a high-bandwidth memory (HBM) associated with the GPU; performing the firmware update subsequent to the workflow application being controlled and the snapshot being captured; and causing the OS driver to resume the execution of the workflow application based at least on the snapshot and after completion of the firmware update. Operating environment 100 can also be utilized for implementing aspects of methods 800, 900, and 1000 in FIGS. 8, 9, and 10, respectively.

Referring now to FIG. 2A, depicted is a block diagram of an example system 200 including a node 202, in accordance with an embodiment of the present disclosure. As illustrated, the system 200 includes a rack 201 including any number of nodes 202. As illustrated, the node 202 includes a motherboard 210 having a central processing unit (CPU) 212; a motherboard (MB) baseboard management controller (BMC) 220; and discrete accelerators, such as the illustrated GPUs 230A and 230B through 230N. In one embodiment, the node 202 refers to an individual self-contained server unit within the rack 201. In one example, the node 202 runs applications, processes data, and performs various tasks. Certain nodes 202 vary in terms of processing power, memory, storage, and other specifications. In a data center, nodes 202 can be organized into a cluster or network to collectively handle the computational and storage needs of applications. In one embodiment, node 202 corresponds to node 1230 of FIG. 12.

In one example, the mother board (MB) BMC 220 corresponds to a controller that monitors the operating parameters of the node and determines whether the operating parameters are within or outside of a target range. An example operating parameter includes power consumption. In some embodiments, the MB BMC 220 directly communicates control signals to the GPUs to control the GPU's execution of a workflow or performing a firmware update. In another example, the MB BMC 220 communicates the control signals to the motherboard 210, causing the motherboard 210 to control the execution of a workflow or performing a firmware update.

In one example, a “rack,” “server rack,” or “data center rack” refers to an assembly of multiple nodes 202 or servers, each with its own motherboard 210. The nodes 202 within the rack 201 work together to deliver the computational power and services for large-scale data center operations. The arrangement of nodes 202 in the rack 201 can vary depending on the specific needs and configurations of the data center. In one example, the “motherboard” refers to the main circuit board of the node 202 and includes a CPU 212, a memory (such as that illustrated in FIGS. 11 and 12), and other components that enable the node 202 to function. The motherboard serves as the central hub for connecting all the hardware components within a server. The motherboard can provide various interfaces and connectors for networking, storage, and expansion options, thereby connecting and facilitating communication between all the server's parts.

In some embodiments, the node 202 runs and implements artificial intelligence (AI) and machine learning (ML) based on workflows submitted by user devices via corresponding applications. Although the illustrated embodiments include GPUs 230A and 230B through 230N, in one embodiment, nodes 202 that run these AI and ML workflows have 4 accelerators, 8 accelerators, 16 accelerators, 64 accelerators, or any suitable number of accelerators.

To facilitate controlling the GPUs 230, the node 202 employs any suitable interface connecting the motherboard 210 to the GPUs 230. In a first non-limiting example, the node 202 employs Peripheral Component Interconnect Express (PCIe), such as PCIe Form Factor (FF) to facilitate the motherboard 210 in controlling the GPUs 230, as well as implementing the embodiments disclosed herein. In one example, the “PCIe” refers to a high-speed interface used for connecting various hardware components inside a node 202 to enable the execution of computationally intensive tasks, such as AI and ML workflows. In some instances, different generations of PCIe (for example, PCIe 3.0, PCIe 4.0, or PCIe 5.0) offer varying levels of bandwidth and performance, with certain newer versions of PCIe providing faster data transfer speeds and improved GPU performance (for example, lower latency) when paired with motherboard 210.

In a second non-limiting example, the node 202 employs Open Compute Project (OCP) Accelerator module (OAM), such as OAM Form Factor (FF), to facilitate the motherboard 210 in controlling the GPUs 230, as well as implementing the embodiments disclosed herein. In one example, the “OAM” refers to a high-speed interface used for connecting various hardware components inside a node 202 to enable the execution of computationally intensive tasks, such as AI and ML workflows.

In one embodiment, AI or ML workloads are classified as AI training workloads, AI inference workloads, or any other classification. In one example, AI training workloads are run across multiple racks in a cluster to train one or more models based on training models. However, certain AI training workloads can be run across multiple clusters. On the other hand, in one example, AI inference workloads run within a rack on one or more nodes 202 to perform AI-related tasks, such as predictions, classifications, and generation of content, such as text, images, video, music, sounds, and the like. In some embodiments, AI inference workloads consume less compute power than AI training workloads. It should be understood that this disclosure is not limited to AI or ML workloads, such as those described herein, because the embodiments disclosed herein facilitate performing other additional or alternative tasks, such as rendering, gaming, or other GPU-based workloads. Indeed, in some embodiments, a combination of AI or ML tasks, as well as other GPU-based workloads can be performed by the components of node 202 or the rack.

FIG. 2B is a block diagram of an example system 250 including a node 202, in accordance with an embodiment of the present disclosure. As illustrated, the system 200 includes a rack 201 including a node 202. As illustrated, the node 202 includes a motherboard 210 having a CPU 212; an MB BMC 220; a PCIe Switch 260; a universal baseboard (UBB) 270 having discrete accelerators, such as the illustrated GPUs 230A and 230B through 230N; and a UBB BMC 280. In one example, the PCIe switch 260 refers to a hardware component that manages and routes PCIe connections between various devices of system 250. In one embodiment, the PCIe switch manages device expansion, load balancing, redundancy, and bandwidth among devices connected to the motherboard 210.

In one embodiment, the UBB 270 refers to a hardware component designed to accommodate and support various types of computer-on-modules (COMs) or system-on-modules (SOMs), such as the illustrated GPUs 230A through 230N. In one embodiment, the UBB 270 provides a common interface, connectors, and peripherals that can be used with different COMs, SOMs, and GPUs 230A through 230N. Example UBBs 270 include connectors, interfaces, power management, and various input/output (I/O) options (such as universal serial bus [USB], Ethernet, high-definition multimedia interface [HDMI], general-purpose input/output [GPIO], and the like), making UBBs compatible with a range of SOMs, COMs, and/or GPUs 230A through 230N, for example, from various manufacturers. By allowing the interoperability of various SOMs, COMs, and/or GPUs 230A through 230N, the UBB 270 can facilitate the development process and promote interchangeability of processing modules while reducing the burdens for custom hardware design. In this manner, certain embodiments of the node 202 employ the UBB 270 and switch out the SOMs, COMs, and/or GPUs 230A through 230N, as needed for different workflows and applications to avoid having to design a custom baseboard for each SOM, COM, and/or GPU 230A through 230N.

In one embodiment, the UBB BMC 280 corresponds to a controller that monitors the operating parameters of the UBB 270 or the one or more GPUs 230A through 230N and determines whether to install a firmware update or cause a snapshot to be captured. As discussed herein, embodiments of the UBB BMC 280 control the execution of tasks associated with a workflow and the performance of a firmware update across GPUs 230 of the node 202. For example, the UBB BMC 280 directly communicates control signals to the GPUs 230 to control the GPU's execution of tasks associated with a workflow based on whether a firmware update is available for installation. In another example, the UBB BMC 280 communicates the control signals to the motherboard 210 or the PCIe switch 260 to cause the motherboard 210 or PCIe switch 260 to control the GPUs 230.

Unlike system 200, system 250 includes a node 202 having the PCIe switch 260; the UBB BMC 280; and the UBB having GPUs 230A and 230B through 230N. For example, whereas in system 200 the MB BMC 280 sends the control signals (for example, to coordinate execution of a workflow with installation of a firmware update) to the GPUs 230A and 230B through 230N; in system 250, MB BMC 220 sends the control signals to the UBB BMC 280. In one embodiment, the UBB BMC 280 submits control signals to the GPUs 230A and 230B through 230N (for example, via slots or OAMs) to control the GPUs 230. In one example, submitting the control signals to the GPUs 230A and 230B through 230N includes causing a snapshot of the HBM of the GPU to be taken, writing the firmware update directly to the GPU, and resuming the workflow from the snapshot after writing the firmware update to the GPU. Example commands include “Capture Snapshot,” “Install Firmware Update,” and the like, which are directly written to the GPUs using Intelligent Platform Management Interface (IPMI) or REDFISH®. In one example, “IPMI” refers to an open, industry-standard interface that was designed for the management of server systems over a number of different types of networks. IPMI functionality includes field-replaceable unit (FRU) inventory reporting, system monitoring, logging of system events, system recovery (including system resets and power-on and power-off capabilities), and alerting, to name a few.

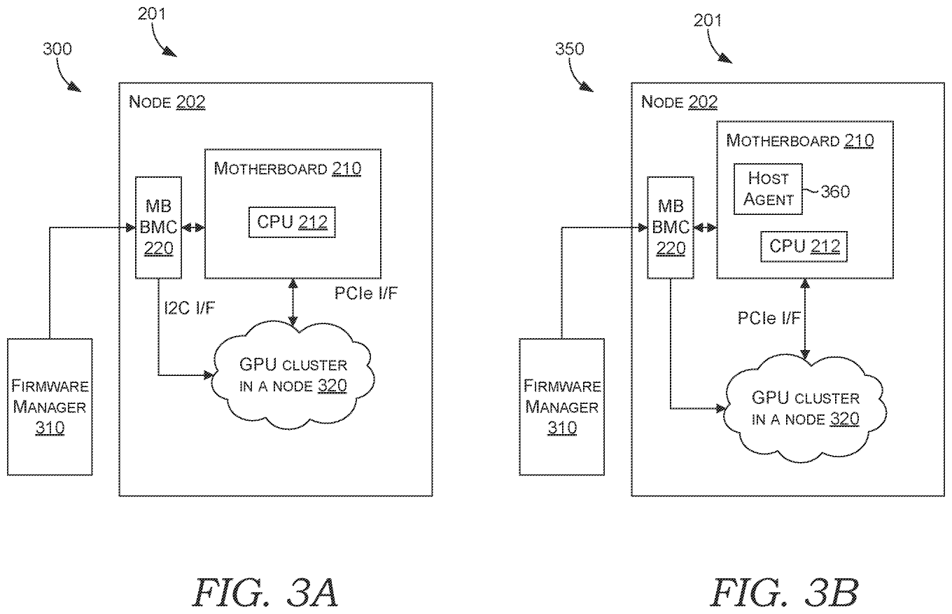

Turning to FIG. 3A, depicted is a block diagram of an example system 300 including a node 202 having an MB BMC 220 configured to control installation of a firmware update and coordinate installation with a workflow. In general, a data center can include a plurality of racks, such as rack 201, which in turn can include a plurality of nodes 202 tasked with performing task-specific workflows. In the context of artificial intelligence (AI), certain nodes 202 perform AI-based workloads, such as training or inference workloads, to name a few examples. In general, a cluster 320 can include a collection of data center components (such as GPUs 230) across a distributed system. To efficiently perform computations across the distributed network, a cluster 320 can include GPUs that are specialized or tasked with performing certain tasks, such as the AI-based workloads described herein.

Continuing with FIG. 3A, the illustrated system 300 includes a firmware manager 310 communicatively coupled to the node 202, for example, via the MB BMC 220. In some embodiments, the firmware manager 310 corresponds to a hardware processor that is cluster-specific (for example, each cluster includes a corresponding firmware manager 310), rack-specific (for example, each rack 201 includes a corresponding firmware manager 310), node-specific (for example, each node 202 includes a corresponding firmware manager 310), or GPU-specific. In a first example, the firmware manager 310 determines whether any firmware updates are ready for installation, and whether the firmware update has been installed on GPUs of the nodes 202 (such as all nodes 202) of the rack 201. Based on a firmware update being available and not yet installed on at least one GPU of the node 202, the firmware manager 310 can communicate to the MB BMC 220 or any other component of the node 202 of the firmware and associated software for installation. Additionally or alternatively, in one embodiment, the firmware manager 310 communicates an indication of the firmware update to the MB BMC 220 or any suitable component of the node 202.

Turning to FIG. 3B, depicted is a block diagram of an example system 350 including a node 202 having a host agent 360 configured to control installation of a firmware update and coordinate installation with a workflow, in accordance with an embodiment of the present disclosure. As illustrated, system 350 includes rack 201 communicatively coupled to the firmware manager 310. In one embodiment, the firmware manager 310 couples to the MB BMC 220 of the node 202 to control the GPUs 230 (FIG. 2) via any component of the motherboard 210, such as the host agent 360 or the CPU 212. As compared to system 300 of FIG. 3A, the example system 350 of FIG. 3B includes a motherboard 210 having a host agent 360. In one example, a host agent 360 refers to one or more software packages installed on the motherboard 210 to facilitate monitoring and management of any suitable components of the rack 201. In some embodiments, the host agent 360 performs tasks such as gathering data, analyzing the data, performing actions (for example, accessing a firmware update, pausing a workflow, taking a snapshot of the workflow, installing the firmware update, and/or resuming the workflow from the snapshot), managing credentials (for example, executing tasks like the configured domain name system [DNS] command to controlling credential management and block volume management), and/or executing any suitable commands. In one instance, the host agent 360 communicates data indicative of potential security threats, performance issues, and other problems.

In certain embodiments of system 350, the host agent 360 of the motherboard 210 submits query requests to receive, from the MB BMC 220, an indication of whether a new version of firmware is available to the node or whether a workflow is being executed by GPUs 230 of the node. In this manner, the MB BMC 220 can receive or access up-to-date firmware updates and/or indications of whether certain workflows are being executed. In some embodiments, the MB BMC 220 determines that a firmware update is ready for installation. In response, embodiments of the host agent 360 cause a coordinator operating system (OS) driver of a GPU 230 to control (for example, pause) a workflow application being hosted or executed on the GPU 230. Thereafter, embodiments of the host agent 360 capture a snapshot of a space on the HBM of a GPU 230 on which content associated with the workflow is stored. In one embodiment, the GPU 230 performs the firmware update after the workflow is paused and the snapshot is captured. In this example, the workflow execution is resumed after one aspect of the firmware update is completed.

Although certain embodiments of system 350 are discussed in the context of performing a firmware update on one GPU, it should be understood that the MB BMC 220 can also install any suitable firmware update on CPU 212 in the nodes 202. For example, in one embodiment, the MB BMC can control the CPU 212 to coordinate installation of a firmware update with execution of certain computer commands executed by the CPU 212.

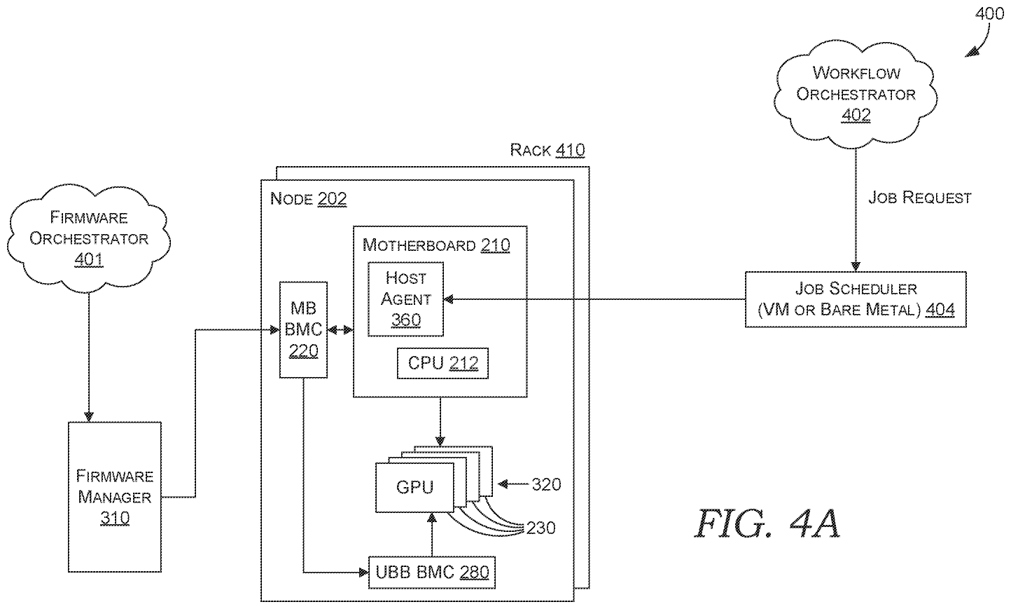

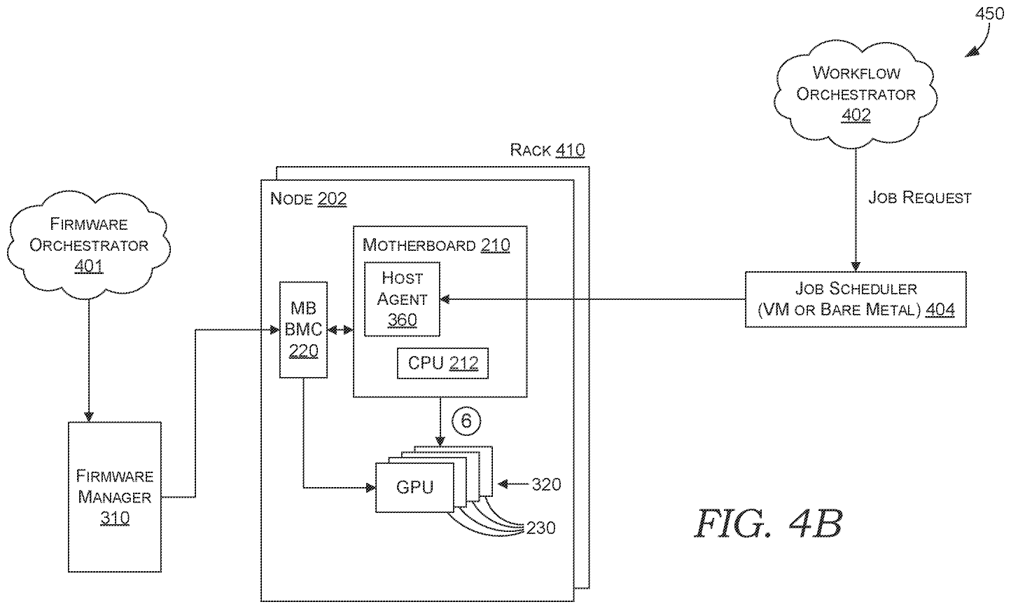

Turning to FIGS. 4A and 4B, depicted are block diagrams of example systems 400 and 450 having a rack 410 including a node 202, having certain components, that coordinates installation of a firmware update with a workflow, in accordance with an embodiment of the present disclosure. The example system 450 of FIG. 4B differs from the example system 400 of FIG. 4A in that the example system 450 of FIG. 4B omits the UBB BMC 280. That is, in the example system 450 of FIG. 4B, the MB BMC 220 directly communicates with the GPUs 230. The illustrated node 202 includes the motherboard 210 having the host agent 360 and the CPU 212; the cluster 320 including GPUs 230; and a UBB BMC 280. In one embodiment, one or more components of the node 202 are directly or indirectly communicatively coupled to at least one of the firmware manager 310, the workflow orchestrator 402, or the job scheduler 404.

In one example, the workflow orchestrator 402 refers to distributed multi-tenant service, such as a software running on a hardware component, that provides unified service abstraction to run or orchestrate workflows across different customers. In one embodiment, the workflow orchestrator 402 executes AI or ML workloads, such as the AI training and inference workloads discussed herein, as well as other suitable tasks. An example workflow orchestrator includes Singularity or Slurm. For example, the workflow orchestrator 402 creates, deploys, or monitors tasks or task execution within one or more VMs running on one or more coprocessors.

In some embodiments, the workflow orchestrator 402 manages the capacity for system 400 to perform tasks, such as AI or ML workflows. In one example, the workflow orchestrator 402 manages the capacity for any system, such as system 450 of FIG. 4B or example computing environment 1200 of FIG. 12, to perform AI or ML workloads. In some embodiments, the workflow orchestrator 402 receives tasks or workflows, for example, from workflow applications. For example, the workflow orchestrator 402 receives tasks or workflows in the order they are submitted, received, or cached.

After receiving the tasks or workflows, embodiments of the workflow orchestrator 402 determine any number of task parameters for the tasks. As a first example, the workflow orchestrator 402 determines, for each task or at least one task, a first task parameter indicative of a computational resource requirement to run the workflow. Continuing this example, the first task parameter includes a number of GPUs that are used to execute the task or workflow, the power consumption associated with performing the task, or any suitable parameter indicative of computational resources used to execute the task.

In some embodiments, the workflow orchestrator 402 is communicatively coupled to the job scheduler 404. In one example, the job scheduler 404 refers to a computing component that monitors file movements within the systems 400 or 450, and assigns the corresponding task to an agent, such as the illustrated host agent 360 for execution. For example, if a predetermined time of a task arrives or a triggering file reaches the job scheduler 404, the job scheduler 404 communicates to the host agent 360 a request to execute the preset task. In one embodiment, the workflow orchestrator 402 communicates the task parameters (for example, the first task parameter indicative of a computational resource requirement to run the workflow and the second task parameter indicative of a series of steps to completion) to the job scheduler 404.

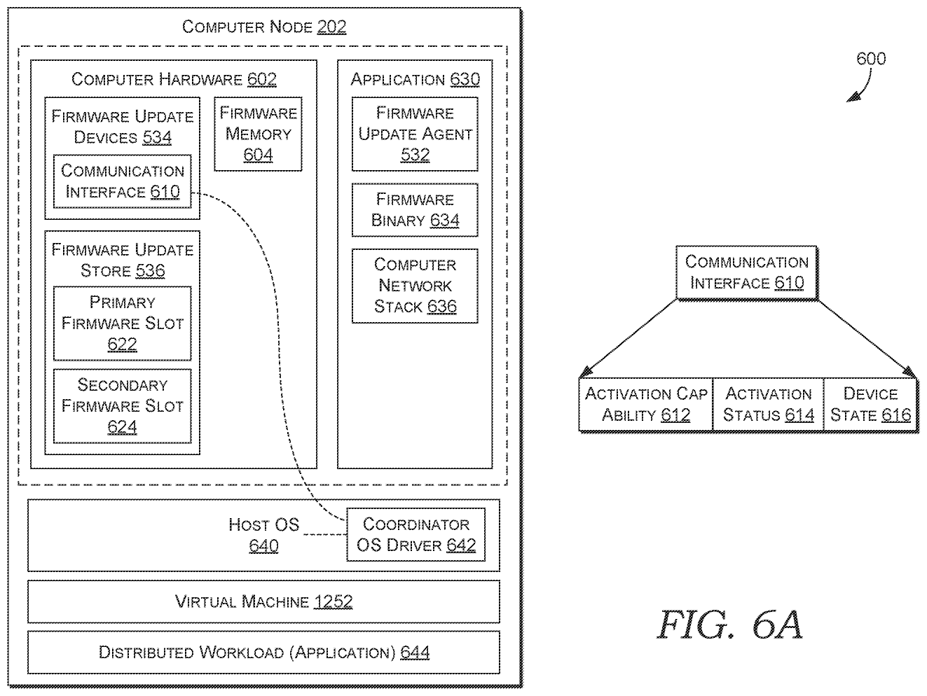

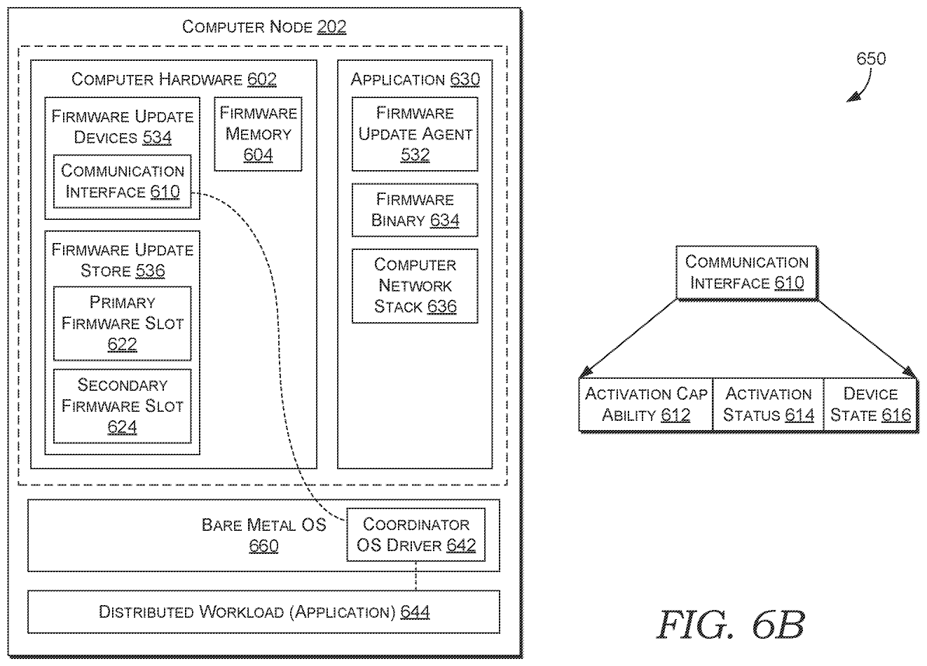

In one embodiment, the job scheduler 404 receives the task parameters, and based on the task parameters, instructs the nodes 202 to create one or more virtual machine (VM) instances or Bare Metal instances. For example, the job scheduler 404 instructs the GPUs 230 of the node to run a VM instance equipped to execute a workflow. As another example, the job scheduler 404 submits a request to the host agent 360 running on the node 202 to create the instance (VM 1252 of FIGS. 6A and 12; or bare metal OS 660 of FIG. 6B, or any other suitable tenant) for the workflows. For example, the host agent 360 performs Hyper-V virtualization to create one or more VMs using Hyper-V on a system running any suitable operating system, such as WINDOWS® or IOS®. In one embodiment, the instance includes at least one of a CPU 212, host memory (such as memory devices 1112 of FIG. 11), or any number of GPUs 230 allocated for the workflow. In one embodiment, less computationally expensive workflows (such as AI inference, gaming, and the like) are assigned a subset of GPUs 230 attached to the node 202. In another embodiment, more computationally expensive tasks (such as AI training) are assigned all the GPUs 230 in the node 202.

In some embodiments, the job scheduler 404 communicates one or more tasks associated with a workflow to the node 202 (for example, to the GPUs 230 via the host agent 360). In some embodiments, the node 202 directs the workflows through the various components to the GPUs 230 for execution. Simultaneously, in some embodiments, the node 202 accesses firmware updates made available from the firmware orchestrator 401 through the firmware manager 310. For example, the node 202 accesses a request to perform the firmware update associated with the GPU 230. In some embodiments, the firmware update is initially performed on primary nodes, such that the firmware manager 310 communicates the firmware only to nodes or corresponding GPU being tagged as primary components.

Based on the request to perform the firmware update, the illustrated node 202 causes the OS driver of the GPU 230 to control (for example, pause) a workflow application being hosted or executed on the GPU 230. Thereafter, the illustrated node 202 captures a snapshot of content stored on a high-bandwidth memory (HBM) associated with the workflow that was running on the GPU 230. In some embodiments, controlling the workflow application includes deleting a pending command associated with the workflow application (and commands received from or remaining pending at the job scheduler 404), such that the snapshot omits the pending command. Thereafter, based on the request, embodiments of the node 202 perform the firmware update subsequent to the workflow application being paused and the snapshot being captured. For example, the firmware update is installed on the GPU 230, and the GPU 230 is restarted. Subsequent to completion of the firmware update, embodiments of the node 202 cause the OS driver to resume the execution of the workflow based at least on the snapshot.

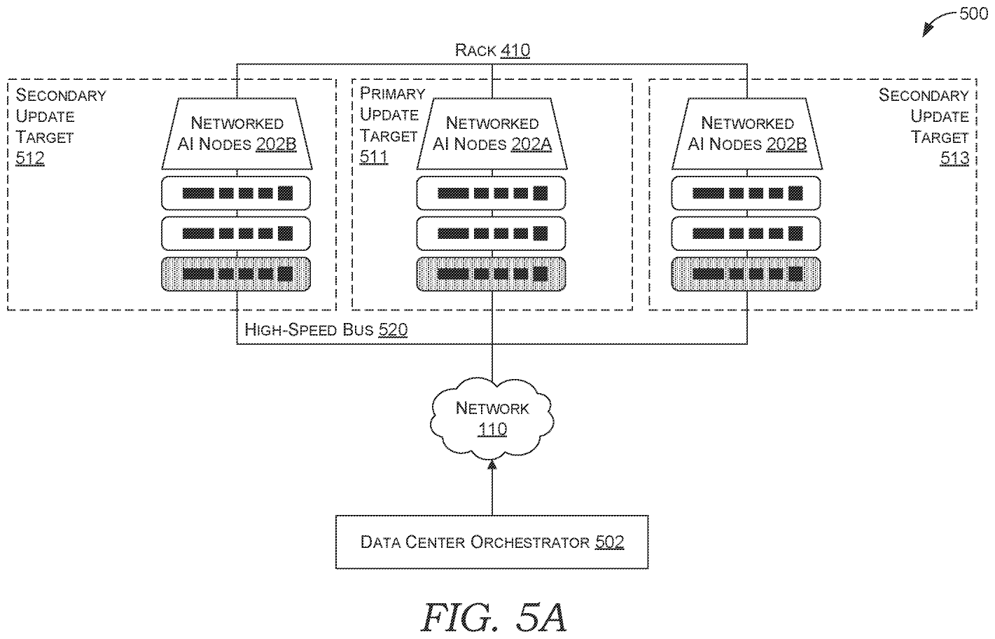

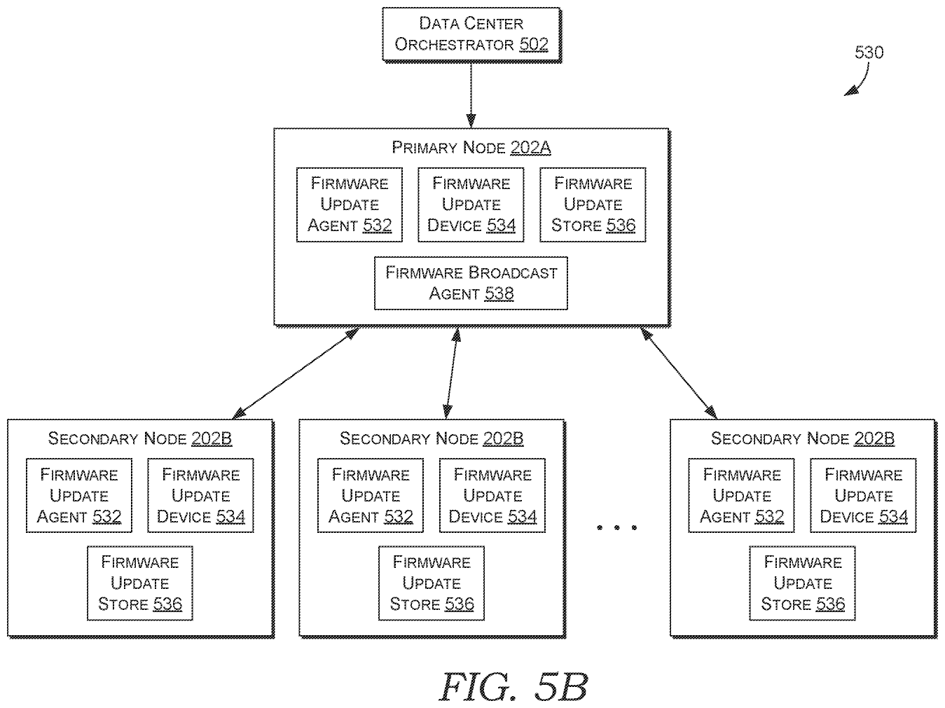

FIG. 5A is a block diagram of an example system 500 including a data center orchestrator 502 communicatively coupled to a rack 410 of nodes 202, in accordance with an embodiment of the present disclosure. In one example, the data center orchestrator 502 comprises at least one of the firmware orchestrator 401 (FIGS. 4A and 4B), the firmware manager 310 (FIGS. 3A and 3B), the workflow orchestrator 402 (FIGS. 4A and 4B), or the job scheduler 404 (FIGS. 4A and 4B). For example, the data center orchestrator 502 communicates workflows to the nodes 202 or communicates firmware updates to the nodes 202. In some embodiments, the firmware orchestrator 401 is separate from the workflow orchestrator 402.

As illustrated, the rack 410 includes a first set 511 of nodes 202, a second set 512 of nodes 202, and a third set 513 of nodes 202. However, the embodiments described herein are not limited to nodes organized into discrete racks 410, as these embodiments may also be implemented for any suitable nodes 202 organized in any suitable configuration. In this example, the first set 511 of nodes 202 corresponds to primary nodes 202A. In one example, the data center orchestrator 502 is only communicatively coupled to primary nodes 202A, which in this example correspond to the first set 511 of nodes 202. In some embodiments, the data center orchestrator 502 submits discovery probe requests to determine available nodes 202. In response to the probe request, embodiments of the data center orchestrator 502 receive an indication of a classification tagging of the nodes 202 in the rack. In one example, the classification tags correspond to an indication of the type of node, such as whether the node 202 corresponds to a primary node 202A or a secondary node 202B. Alternatively, the data center orchestrator 502 receives a data file defining a classification of the nodes 202.

In response to receiving an indication that the node 202 corresponds to a primary node 202A, the data center orchestrator 502 determines whether the primary node 202A has GPUs or other hardware components running a target version of firmware (for example, the most recent version). By checking if a firmware needs to be implemented, certain embodiments ensure that hardware in data centers remains up-to-date with the latest software patches to improve the lifespan and operation, as well as to reduce the wear and tear experienced by hardware components. In response to the primary node 202A not running the target version of firmware, the data center orchestrator communicates, over network 110, the firmware update to the first set 511 of primary nodes 202A. The primary node 202A can coordinate execution of a workflow with installation of a firmware update by controlling the workflow to pause execution of the workflow, taking a snapshot of content of a workflow application associated with the workflow, and continuing execution of the workflow based on the snapshot and after an aspect of the firmware update has been installed on the GPU.

In some embodiments, the primary node 202A communicates the firmware update to neighboring nodes. In this example, the primary node 202A simultaneously communicates the firmware update from the data center orchestrator 502 to the secondary nodes 202B, which in this example are part of the second set 512 and third set 513 of nodes 202. In one embodiment, the primary node 202A leverages circuitry, such as high-speed bus 520 of FIG. 5A, connecting the GPUs or nodes 202 to communicate the firmware update to other neighboring nodes or GPUs. In this manner, the GPUs of the secondary nodes 202B can receive the firmware and perform the firmware update in parallel. For example, the secondary nodes 202B can coordinate execution of a workflow with installation of a firmware update by controlling a workflow running on the secondary nodes 202B to pause execution of the workflow, taking a snapshot of content of a workflow application associated with the workflow, and continuing execution of the workflow based on the snapshot and after an aspect of the firmware update has been installed on the GPU.

Certain embodiments have the technical effect of increasing scalability, allowing computing systems to implement the firmware update in parallel across dozens, hundreds, thousands, or even millions of GPUs or nodes, for example, by initially pushing the firmware update to primary nodes 202A or primary GPUs that then communicate the firmware to neighboring nodes, such as the illustrated secondary nodes 202B and corresponding GPUs.

Similar to the embodiment illustrated in FIG. 5A, FIG. 5B depicts a block diagram of an example system 530 including a data center orchestrator 502 communicatively coupled to a primary node 202A, which is communicatively coupled to a plurality of secondary nodes 202B, in accordance with an embodiment of the present disclosure. The illustrated primary nodes 202A and secondary nodes 202B include a firmware update agent 532, a firmware update device 534, and a firmware update store 536. In one embodiment, the firmware update agent 532 includes software components to perform aspects of the firmware update. For example, the firmware update agent 532 is responsible for collecting data associated with the firmware update, managing execution of the firmware update, and/or managing communications associated with the firmware update. Embodiments of the firmware update agent 532 of the primary node 202A collect data associated with the firmware update from the data center orchestrator 502. Embodiments of the firmware update agent 532 of the secondary nodes 202B collect data associated with the firmware update from the primary node 202A, so that the secondary nodes 202B can perform the firmware updates in parallel after the data center orchestrator sends the firmware update to the primary node 202A instead of all the nodes 202.

In some embodiments, the firmware update device 534 includes a physical hardware or virtual machine hosting certain software, such as the firmware update agent 532. In one embodiment, the firmware update device 534 includes any of the hardware devices illustrated in the nodes 202 of FIGS. 2A, 2B, 3A, 3B, 4A, and 4B, such as the GPUs 230.

In some embodiments, the firmware update store 536 includes a storage system that stores firmware files. In one example, the firmware includes a type of software that provides low-level control for the specific hardware it is designed for, such as the GPU 230 (FIGS. 2A and 2B) or other components of nodes 202. Embodiments of the firmware update store 536 allow the firmware update agent 532 or the firmware update device 534 to perform the firmware update and store the associated data onto the firmware update store 536. In this manner, the firmware update store 536 includes one or more versions of the firmware to improve efficiency and operation of the GPU 230 by allowing the GPU to access the target firmware and operate accordingly.

In some embodiments, the primary node 202A includes a firmware broadcast agent 538. The firmware broadcast agent 538 generally refers to a software component or collection of hardware components responsible for communicating the firmware update, received from the data center orchestrator 502, to other neighboring nodes. In the illustrated embodiment, after the primary node 202A receives the firmware update from the data center orchestrator 502, the firmware broadcast agent 538 communicates the firmware update to at least one of the neighboring nodes, such as the secondary nodes 202B. In one example, the firmware broadcast agent 538 communicates the firmware update in parallel to the neighboring secondary nodes 202B. For example, the firmware broadcast agent 538 communicates, in parallel, the firmware update to the three illustrated secondary nodes 202B. In some embodiments, the firmware broadcast agent 538 communicates the firmware update serially instead of or in addition to in parallel.

After the firmware update has been installed, the node on which the firmware update has been installed may communicate an indication of the completed installation. For example, after the secondary node 202B completes installation of the firmware update, the secondary node 202B communicates a completion indication to the primary node 202A. After all (or a threshold quantity of) neighboring secondary nodes 202B have performed the firmware update and communicated the completion indication to the primary node 202A, embodiments of the primary node 202A communicate the completion indication to the data center orchestrator 502. In this manner the data center orchestrator 502 can have an indication of which nodes 202 have been updated with the firmware update.

FIG. 6A is a block diagram of an example system 600 including a node 202 in which performing a workflow is coordinated with performing a firmware update, in accordance with an embodiment of the present disclosure. The illustrated node 202 includes computer hardware 602 that includes firmware memory 604; a firmware update device 534 having a communication interface 610 that includes an activation capability 612, an activation status 614, and a device state 616; a firmware update store 536 having a primary firmware slot 622 and a secondary firmware slot 624. The illustrated node 202 further includes an application 630 having a firmware update agent 532, firmware binary 634, and a computer network stack 636. The illustrated node 202 includes a host OS 640 having a coordinator OS driver 642. The illustrated node 202 further includes a VM 1252 and distributed workflow application 644. As compared to FIG. 6A, FIG. 6B omits the host OS 640 and the VM 1252, but includes a bare metal OS 660 having the coordinator OS driver 642. The VM 1252 is discussed in detail with respect to FIG. 12. The bare metal OS 660 is one type of OS, but the embodiments described herein may be implemented in association with other OSs.

The illustrated computer hardware 602 includes any suitable hardware device of the node 202, such as those illustrated in FIGS. 2A, 2B, 3A, 3B, 4A, and 4B, such as the GPUs 230. The illustrated firmware memory 604 includes any suitable memory device, such as the memory device 1112 of FIG. 11. In some embodiments, the firmware memory 604 includes non-volatile storage on which the firmware update is installed, HBM on which content associated with the workflow is stored, or both. The illustrated firmware update device 534 includes a physical hardware or virtual machine hosting certain software, such as the firmware update agent 532. Embodiments of the firmware update device 534 include hardware components that are designed to perform a firmware update, as discussed herein.

To facilitate coordinating performing the firmware update, the firmware update device 534 includes a communication interface 610 that communicatively couples the firmware update device 534 to the coordinator OS driver 642. In some embodiments, a GPU 230 not having the communication interface 610 is unable to receive the request to perform the firmware update from the firmware orchestrator 401 of FIG. 4A or the illustrated coordinator OS driver 642. In one embodiment, the communication interface 610 includes an interface at any suitable abstraction layer associated with the firmware update device 534 (for example, the hardware layer, the application layer, the OS layer, and the like). In this manner, the firmware update device 534 can receive control instructions or commands from the coordinator OS driver 642 to queue the firmware update, perform an aspect of the firmware update, pause installation of the firmware update, and so forth.

Embodiments of the activation capability 612 provide instructions for initiating installation of the firmware update on the firmware update device 534. For example, the activation capability 612 receives the firmware update from a firmware orchestrator 401 (FIGS. 4A and 4B) and causes the firmware update device 534 to initiate the firmware update after the snapshot has been captured. To determine progress in performing the firmware update, the communication interface 610 includes an activation status 614. The activation status 614 monitors performing the firmware update and assigns an indication of progress in performing the firmware update. For example, the activation status 614 indicates a percentage of completion in installing the firmware update. In some embodiments, the computer hardware 602 is powered off to perform the firmware update. The device state 616, in one example, refers to a component that controls power to the computer hardware 602 and determines the state (for example, powered on or powered off of the computer hardware 602). In some embodiments, components 612, 614, and 616 perform these operations based on control instructions or commands from the coordinator OS driver 642.

In some embodiments, the firmware update store 536 includes a storage device, such as non-volatile storage, capable of storing at least one version of the firmware associated with a respective firmware update. In one embodiment, each version of firmware is stored in a designated spot in the firmware update store 536. In the illustrated example, the firmware update store 536 includes a primary firmware slot 622 and a secondary firmware slot 624.

As a first example, a firmware update performed by the firmware update device 534 is stored in the primary firmware slot 622, while older versions of the firmware are stored in the secondary firmware slot 624. In this example, the slot having the most recent version of the firmware update is classified as the primary firmware slot 622, while the slot having older versions of the firmware update is classified as the secondary firmware slot 624.

In a second example, installation of the firmware update can be divided into multiple installations or aspects, such that a first part of the firmware update is stored in the primary firmware slot 622 and a second part of the firmware update is stored in the secondary firmware slot. In this example, the two parts of the firmware update collectively form the entire firmware update. By dividing the firmware update into multiple parts or aspects, the firmware update can be installed at different time intervals, for example, between breaks in performing the workflow to reduce downtime for customers.

As discussed herein, the node 202 can run any number of software applications, such as application 630. In one embodiment, the firmware update agent 532 of the application 630 is generally responsible for collecting data associated with the firmware update, managing execution of the firmware update, and/or managing communications associated with the firmware update, as discussed herein. In one embodiment, the firmware binary 634 refers to low-level software stored on a hardware component, such as non-volatile memory, and that provides instructions for the hardware component to operate. The firmware binary 634 can provide instructions for the components of the node 202 to operate. For example, the firmware binary 634 includes ones and zeros, or other forms of code that facilitate communication between certain hardware components of the node 202 and higher-level software.

In one embodiment, the computer network stack 636 (also referred to in one example as a “protocol stack”) of the node 202 refers to a set of protocols that govern communication between devices in a computer network, such as network 110 (FIG. 1). Certain computer network stacks 636 include layers, such as a physical layer, a data link layer, a network layer, a transport layer, a session layer, a presentation layer, and an application layer. In this example, each layer serves a specific function, which when implemented together enable reliable and standardized communication across the network. Example computer network stacks 636 include the Open Systems Interconnection (OSI) model and the Transmissions Control Protocol (TCP/IP) protocol.

In some embodiments, the host OS 640 refers to the main OS running on the motherboard 210 (FIGS. 2A and 2B) of the node 202. Embodiments of the host OS 640 manage hardware resources, provide a user interface, run applications, initiate performing a firmware update, and perform other operations. For example, the host OS 640 includes a dedicated component, such as the illustrated coordinator OS driver 642, responsible for coordinating and implementing a workflow associated with distributed workflow application 644 with performing a firmware update.

For example, the coordinator OS driver 642 transmits, from the host OS 640 and to the communication interface 610 of the firmware update device 534, a request to perform a firmware update on the computer hardware 602 (for example, the GPU 230). Before causing the computer hardware 602 to perform the firmware update, in this example, the coordinator OS driver 642 causes the computer hardware 302 to capture a snapshot of the firmware memory 604 (for example, the HBM) to capture a data associated with the workflow associated with the distributed workflow application 644. Continuing this example, the coordinator OS driver 642 controls the distributed workflow application 644 being hosted or executed in association with the computer hardware 602 until completion of an aspect of the firmware update. Controlling this distributed workflow application 644 may include pausing the workflow application 644 at the time the snapshot is captured. After receiving an indication of the completion of the aspect of the firmware update, embodiments of the coordinator OS driver 642 instruct the distributed workflow application 644 to execute the workflow based on the snapshot.

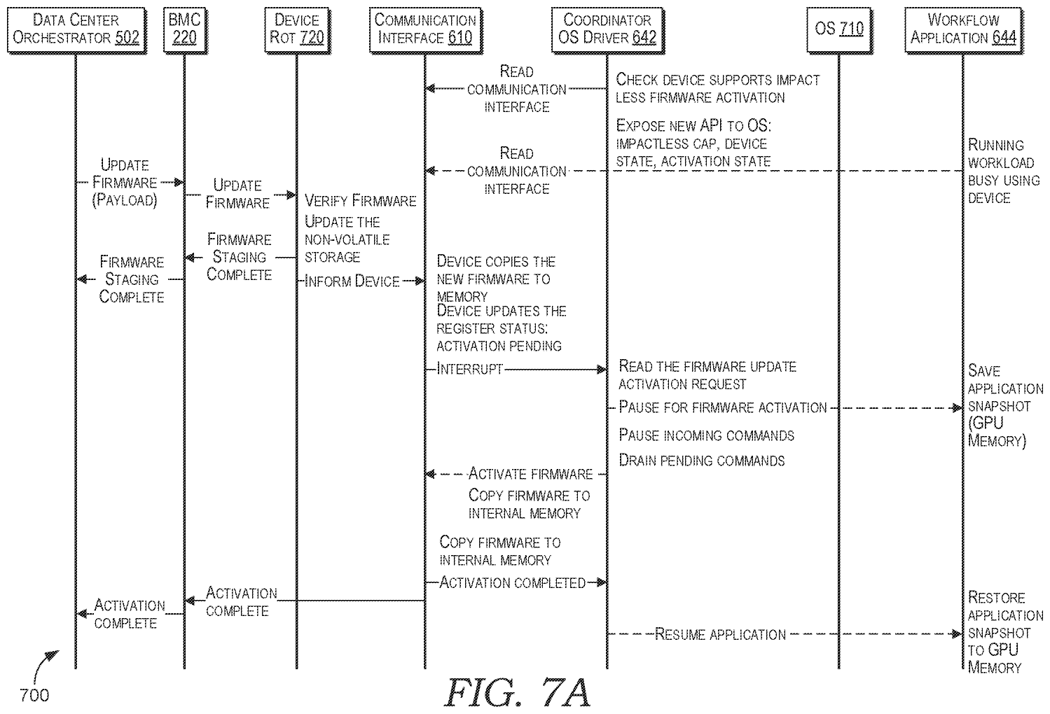

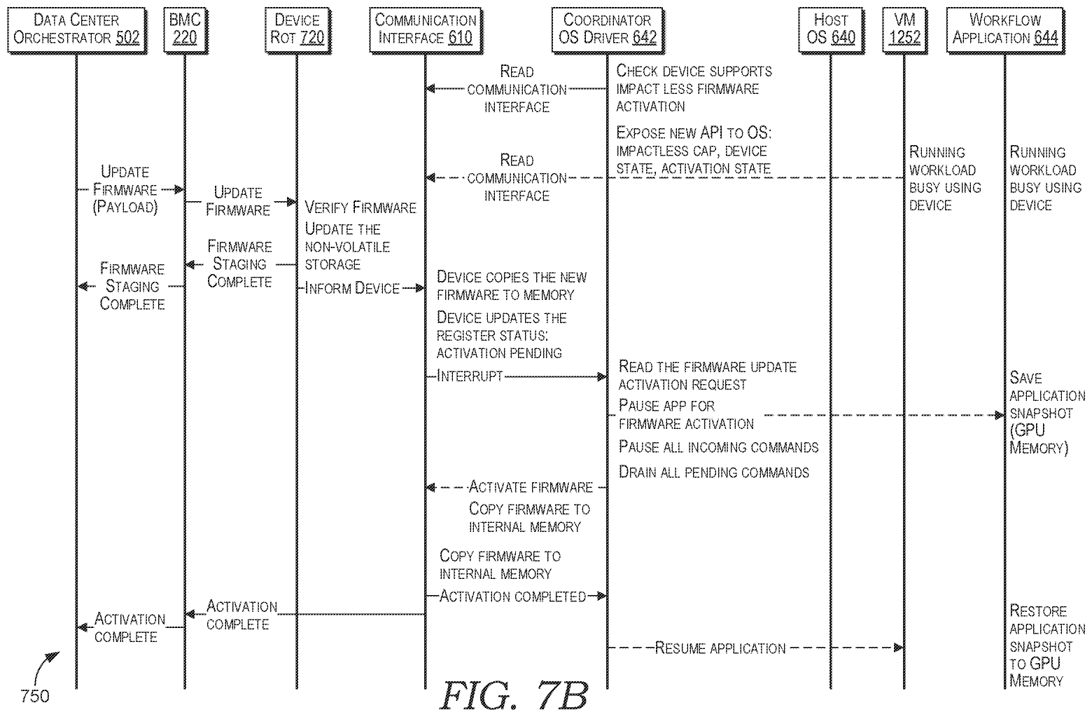

FIGS. 7A and 7B are flow diagrams 700 and 750 of the interaction of computing components to coordinate performing a workflow with performing a firmware update, in accordance with an embodiment of the present disclosure. Certain components illustrated in FIG. 7A correspond to components depicted in FIG. 6A, and certain components illustrated in FIG. 7B correspond to components depicted in FIG. 6B. Whereas FIG. 7B includes VM 1252, FIG. 7A instead includes OS 710. For the sake of simplicity, FIGS. 7A and 7B are described concurrently below.

With reference to the flow diagrams 700 and 750, the coordinator OS driver 642 checks if the device, such as GPUs 230 (FIGS. 2A and 2B) of node 202 (FIGS. 2A and 2B), supports the firmware update installation with reduced impact to the workflow, as discussed herein. In one embodiment, the coordinator OS driver 642 does this by exposing the coordinator OS driver 642 to an application programming interface (API) associated with the communication interface 610 of the GPU 230. In the illustrated flow diagram 700 of FIG. 7A, the workflow application 644 is running on OS 710; while in the illustrated flow diagram 750 of FIG. 7B, the VM 1252 and/or the host OS 640 is running a workflow associated with workflow application 644. The OS 710 can correspond to the host OS 640 of FIG. 6A or the bare metal OS 660 of FIG. 6B.

While the workflow is being executed, the illustrated data center orchestrator 502 communicates a payload associated with the firmware update to the BMC 220. In response, the BMC 220 communicates the firmware update to the device root of trust (ROT) 720. In one example, the device ROT 720 refers to a hardware-based security mechanism that integrates a device, such as the computer hardware 602 (FIGS. 6A and 6B) or GPU 230, to various components. In some embodiments, the device ROT 720 includes a secure element or module responsible for tasks, such as secure boot, cryptographic operations, and system (such as node 202) protection from unauthorized access. The illustrated device ROT 720 verifies that the firmware update complies with one or more security parameters of a security policy. Based on the firmware update complying with the security parameters, the device ROT 720 informs the GPU 230, via communication interface 610, that a firmware update is ready to be installed. In some embodiments, informing the GPU 230 via the communication interface 610 that a firmware update is ready to be installed includes writing the firmware update to a serial peripheral interface (SPI) associated with non-volatile storage. Thereafter, embodiments of the BMC 220 and the data center orchestrator 502 receive indications that the firmware update has been staged for future installation.

Continuing with flow diagram 700, the GPU 230 copies, via communication interface 610, the firmware associated with the firmware update onto pre-reserved memory, such as the firmware update store 536 or internal static random-access memory (SRAM). In doing so, certain embodiments of the communication interface 610 update the activation status 614 to “activation pending.” As illustrated, GPU 230 communicates, via the communication interface 610, a command to the coordinator OS driver 642 to control the workflow associated with workflow application 644. In one embodiment, controlling the workflow causes the coordinator OS driver 642 to read the command from the communication interface 610 and wait to execute the firmware update until the workflow application 644 pauses execution of the workflow. As illustrated, the coordinator OS driver 642 pauses commands from the workflow application 644 to stop executing the associated workflow and deletes pending commands from the workflow application 644.

Continuing the flow diagram 700, the coordinator OS driver 642 instructs the workflow application 644 to save content associated with the workflow as a snapshot on the HMB of the GPU 230. In response to the snapshot being captured, the communication interface 610 saves the firmware update to internal memory, such as non-volatile storage. After performing the firmware update, the GPU 230 signals, via the communication interface 610, to the coordinator OS driver 642 that the firmware update is complete. In response to receiving an indication that the firmware application is complete, the coordinator OS driver 642 GPU driver instructs the workflow application 644 to resume executing the workflow from the snapshot. For example, the workflow application 644 restores the content from the snapshot onto the HBM of the GPU and continues executing the workflow. In some embodiments, causing the coordinator OS driver to resume the execution of the workflow application based at least on the snapshot comprises communicating to the OS driver an indication that an aspect of the firmware update has been completed on the GPU and restoring the HBM with content from the snapshot. In this example, the workflow application resumes the execution based on the content from the snapshot.

Turning now to FIGS. 8, 9, and 10, aspects of example process flows 800, 900, and 1000 are illustratively depicted for some embodiments of the disclosure. Embodiments of process flows 800, 900, and 1000 each comprise a method (sometimes referred to herein as method 800, 900, and 1000) carried out to implement various example embodiments described herein. For instance, at least one of process flows 800, 900, and 1000 is performed to dynamically coordinate GPU execution of a workflow with installation of a firmware update by controlling the workflow to pause execution of the workflow, capturing a snapshot of content of a workflow application associated with the workflow, and continuing execution of the workflow based on the snapshot and after an aspect of the firmware update has been installed on the GPU.

Each block or step of process flow 800, process flow 900, process flow 1000, and other methods described herein comprises a computing process performed using any combination of hardware, firmware, and/or software. For instance, various functions are carried out by a processor executing instructions stored in memory, such as memory 1112, as described in FIG. 11. Embodiments of the methods can also be embodied as computer-usable instructions stored on computer storage media. Embodiments of the methods are provided by a standalone application, a service or hosted service (standalone or in combination with another hosted service), or a plug-in to another product, to name a few. For example, the blocks of process flow 800, 900, and 1000 that correspond to actions (or steps) to be performed (as opposed to information to be processed or acted on) are carried out by one or more computer applications or services, in some embodiments, which operate on one or more user devices (such as user devices 102a and 102b through 102n of FIG. 1), and/or are distributed across multiple user devices, and/or servers, or by a distributed computing platform, and/or are implemented in the cloud, such as is described in connection with FIGS. 2A, 2B, 3A, 3B, 4A, 4B, 5A, 5B, 6A, 6B, 7A, and 7B. In some embodiments, the functions performed by the blocks or steps of process flows 800, 900, and 1000 are carried out by components of embodiments described in FIGS. 2A, 2B, 3A, 3B, 4A, 4B, 5A, 5B, 6A, 6B, 7A, and/or 7B, respectively.

With reference to FIG. 8, aspects of example process flow 800 are illustratively provided for coordinating the execution of a workflow with the performance of a firmware update with reduced impact to the workflow, in accordance with an embodiment of the present disclosure. As illustrated, at block 802, example process flow 800 includes accessing a request to perform the firmware update associated with at least one graphics processing unit (GPU) of a node. At block 804, example process flow 800 includes causing an operating system (OS) driver of the at least one GPU to control, based on the request, a workflow application being hosted or executed on the at least one GPU. At block 806, example process flow 800 includes capturing a snapshot of content stored on a high-bandwidth memory (HBM) associated with the GPU. At block 808, example process flow 800 includes performing, based on the request, the firmware update subsequent to the workflow application being controlled and the snapshot being captured. At block 810, example process flow 800 includes causing the OS driver to resume the execution of the workflow application based at least on the snapshot and subsequent to completion of the firmware update.

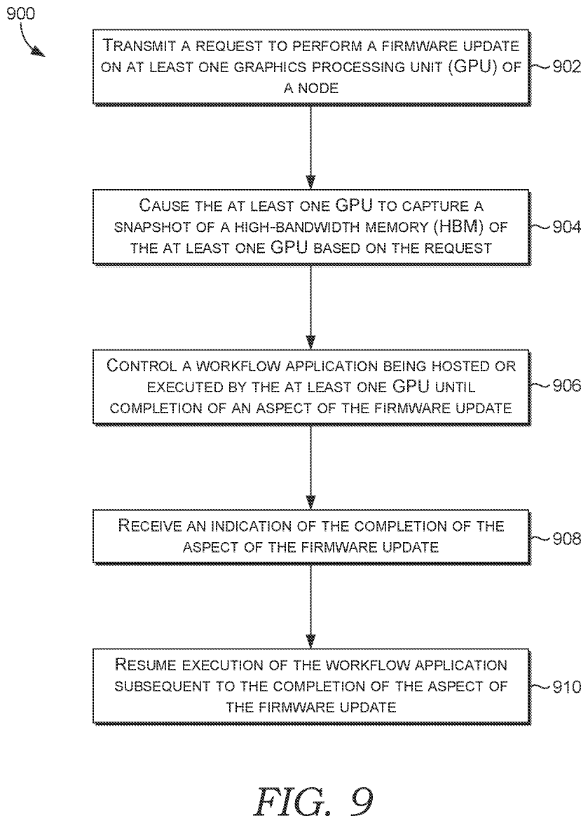

With reference to FIG. 9, aspects of example process flow 900 are illustratively provided for coordinating the execution of a workflow with the performance of a firmware update with reduced impact to the workflow, in accordance with an embodiment of the present disclosure. At block 902, example process flow 900 includes transmitting, via an operating system (OS) driver of at least one graphics processing unit (GPU) of a node, a request to perform a firmware update on the at least one GPU. At block 904, example process flow 900 includes causing the at least one GPU to capture a snapshot of a high-bandwidth memory (HBM) of the at least one GPU based on the request. At block 906, example process flow 900 includes controlling a workflow application being hosted or executed by the at least one GPU until completion of an aspect of the firmware update. At block 908, example process flow 900 includes receiving an indication of the completion of the aspect of the firmware update. At block 910, example process flow 900 includes resuming execution of the workflow application subsequent to the completion of the aspect of the firmware update.

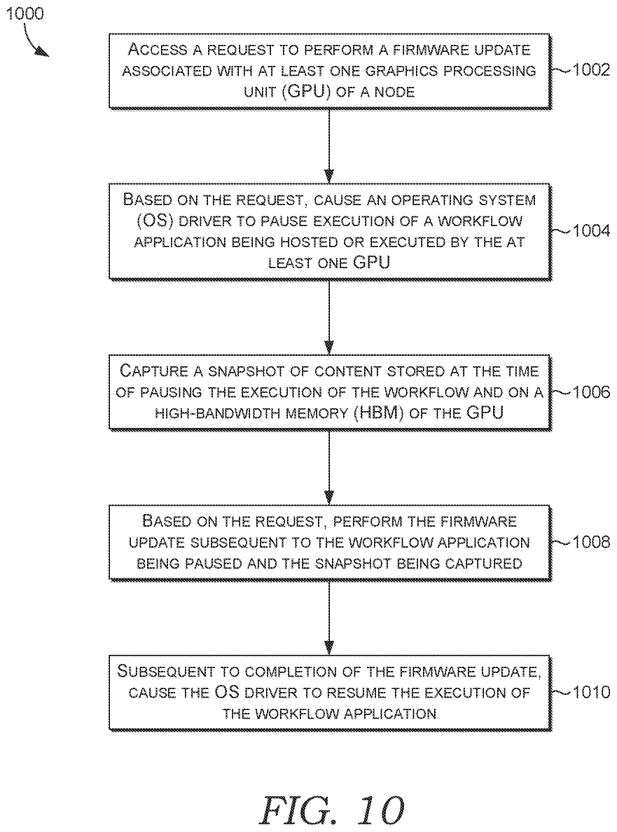

With reference to FIG. 10, aspects of example process flow 1000 are illustratively provided for coordinating the execution of a workflow with the performance of a firmware update with reduced impact to the workflow, in accordance with an embodiment of the present disclosure. At block 1002, example process flow 1000 includes accessing a request to perform a firmware update associated with at least one graphics processing unit (GPU) of a node. At block 1004, example process flow 1000 includes causing, based on the request, an operating system (OS) driver of the at least one GPU to pause execution of a workflow application being hosted or running on the at least one GPU. At block 1006, example process flow 1000 includes capturing a snapshot of content stored at a time of pausing the execution of the workflow application and on a high-bandwidth memory (HBM) associated with the GPU. At block 1008, example process flow 1000 includes, based on the request, performing the firmware update subsequent to the workflow application being paused and the snapshot being captured. At block 1010, example process flow 1000 includes, subsequent to completion of an aspect of the firmware update, causing the OS driver to resume the execution of the workflow application based at least on the snapshot.

### OTHER EMBODIMENTS

In some embodiments, a system to coordinate a firmware update and execution of a workflow, such as the computerized system described in any of the embodiments above, is provided. The system comprises at least one computer processor and computer storage media storing computer-useable instructions that, when used by the at least one computer processor, cause the system to perform operations. The operations comprise accessing a request to perform the firmware update associated with at least one graphics processing unit (GPU) of a node; based on the request, causing an operating system (OS) driver of the at least one GPU to control a workflow application being hosted or executed on the at least one GPU; capturing a snapshot of content stored on a high-bandwidth memory (HBM) associated with the GPU; based on the request, performing the firmware update subsequent to the workflow application being controlled and the snapshot being captured; and subsequent to completion of the firmware update, causing the OS driver to resume the execution of the workflow application based at least on the snapshot.

In any combination of the above embodiments of the system, controlling the workflow application comprises pausing the execution of the workflow application.

In any combination of the above embodiments of the system, controlling the workflow application comprises deleting at least one pending command from the workflow application, wherein the snapshot omits the at least one pending command.

In any combination of the above embodiments of the system, the at least one GPU corresponds to a primary GPU, wherein the firmware update is accessible by the primary GPU from a firmware orchestrator.

In any combination of the above embodiments of the system, the primary GPU communicates the firmware update to a neighboring GPU, and the operations comprise receiving an indication of the completion of the firmware update on the neighboring GPU. In one embodiment, the OS driver causes the execution of the workflow application to resume based on the indication of the completion.

In any combination of the above embodiments of the system, the at least one GPU comprises a communication interface, wherein the at least one GPU communicates with the OS driver via the communication interface.

In any combination of the above embodiments of the system, the request to perform the firmware update is received from a firmware orchestrator, wherein the node comprises another GPU that does not have the communication interface, wherein the other GPU not having the communication interface is unable to receive the request to perform the firmware update from the firmware orchestrator.

In any combination of the above embodiments of the system, the request to perform the firmware update is received from a firmware orchestrator via a baseboard management controller (BMC) of the node, wherein the request is accessed within the node by the at least one GPU from the BMC.

In any combination of the above embodiments of the system, the snapshot comprises at least one of metadata associated with the execution of the workflow application or contextual data associated with the execution of the workflow application.

In any combination of the above embodiments of the system, causing the OS driver to resume the execution of the workflow application based at least on the snapshot comprises: communicating to the OS driver an indication that an aspect of the firmware update has been completed on the at least one GPU; and restoring the HBM with content from the snapshot, wherein the workflow application resumes the execution based on the content from the snapshot.

Various embodiments are directed to computer-implemented methods comprising the following operations: transmitting, via an operating system (OS) driver of at least one graphics processing unit (GPU) of a node, a request to perform a firmware update on the at least one GPU; causing the at least one GPU to capture a snapshot of a high-bandwidth memory (HBM) of the at least one GPU based on the request; controlling a workflow application being hosted or executed by the at least one GPU until completion of an aspect of the firmware update; receiving an indication of the completion of the aspect of the firmware update; and resuming execution of the workflow application subsequent to the completion of the aspect of the firmware update.

In any combination of the above embodiments of the computer-implemented method, further comprising: accessing a respective tagging for a plurality of GPUs; and determining, from the plurality of GPUs, which GPU of the plurality of GPUs has a respective tagging indicative of a primary GPU tagging, and wherein the request to perform the firmware update is transmitted to the GPU having the respective tagging indicative of the primary GPU tagging for communication to neighboring GPUs not having the respective tagging.

In any combination of the above embodiments of the computer-implemented method, the at least one GPU comprises a communication interface communicatively coupled to the OS driver, wherein the OS driver does not communicate the request to another GPU not having the communication interface.

In any combination of the above embodiments of the computer-implemented method, further comprising receiving, from a firmware orchestrator, software associated with the firmware update, wherein the request to perform the firmware update is transmitted, via the OS driver to a baseboard management controller (BMC) of the node.

In any combination of the above embodiments of the computer-implemented method, causing the at least one GPU to capture a snapshot comprises instructing the workflow application to pause and store on the HBM content associated with the workflow at a time of pausing.

In any combination of the above embodiments of the computer-implemented method, controlling the workflow application comprises at least one of: pausing the execution of the workflow application or deleting at least one pending command from the workflow application.

Various embodiments are directed to one or more computer storage media having computer-executable instructions embodied thereon that, when executed, by one or more processors, cause the one or more processors to perform operations. The operations include accessing a request to perform a firmware update associated with at least one graphics processing unit (GPU) of a node; based on the request, causing an operating system (OS) driver associated with the at least one GPU to pause execution of a workflow application being hosted or running on the at least one GPU; capturing a snapshot of content stored at a time of pausing the execution of the workflow application and on a memory device associated with the GPU; based on the request, performing the firmware update subsequent to the workflow application being paused and the snapshot being captured; and subsequent to completion of an aspect of the firmware update, causing the OS driver to resume the execution of the workflow application based at least on the snapshot.

In any combination of the above embodiments of the one or more computer storage media, pausing the execution of the workflow application comprises deleting at least one pending command from the workflow application, wherein the snapshot does not include the at least one pending command.

In any combination of the above embodiments of the one or more computer storage media, the at least one GPU corresponds to a primary GPU, wherein the firmware update is accessible to the primary GPU from a firmware orchestrator.

In any combination of the above embodiments of the one or more computer storage media, the primary GPU communicates the firmware update to a neighboring GPU, wherein the operations comprise receiving an indication of the completion of the aspect of the firmware update on the neighboring GPU, and wherein the OS driver causes the execution of the workflow application to resume based on the indication of the completion.

### Example Computing Environments

Having described various implementations, several example computing environments suitable for implementing embodiments of the disclosure are now described, including an example computing device and an example distributed computing environment in FIGS. 11 and 12, respectively. With reference to FIG. 11, an example computing device is provided and referred to generally as computing device 1100. The computing device 1100 is but one example of a suitable computing environment and is not intended to suggest any limitation as to the scope of use or functionality of embodiments of the disclosure, and nor should the computing device 1100 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher-level software. Accordingly, in some embodiments, computer-executable instructions include any software, including low-level software written in machine code, higher-level software such as application software, and any combination thereof. In this regard, the system components can manage resources and provide services for system functionality. Any other variations and combinations thereof are contemplated within the embodiments of the present disclosure.

With reference to FIG. 11, computing device 1100 includes a bus 1110 that directly or indirectly couples the following devices: memory 1112, one or more processors 1114, one or more presentation components 1116, one or more input/output (I/O) ports 1118, one or more I/O components 1120, and an illustrative power supply 1122. In one example, bus 1110 represents one or more buses (such as an address bus, data bus, or combination thereof). Although the various blocks of FIG. 11 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 11 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 11 and with reference to “computing device.”

Computing device 1100 typically includes a variety of computer-readable media. Computer-readable media can be any available media that can be accessed by computing device 1100 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for storage of information, such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 1100. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1112 includes computer storage media in the form of volatile and/or non-volatile memory. In one example, the memory is removable, non-removable, or a combination thereof. Hardware devices include, for example, solid-state memory, hard drives, and optical-disc drives. Computing device 1100 includes one or more processors 1114 that read data from various entities such as memory 1112 or I/O components 1120. As used herein and in one example, the term processor or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor are performed by more than one processor.

Presentation component(s) 1116 presents data indications to a user or other device. Presentation components include, for example, a display device, speaker, printing component, vibrating component, and the like.

The I/O ports 1118 allow computing device 1100 to be logically coupled to other devices, including I/O components 1120, some of which are built-in. Illustrative components include a microphone, joystick, game pad, satellite dish, scanner, printer, or a wireless device. The I/O components 1120 can provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1100. In one example, the computing device 1100 is equipped with depth cameras, such as stereoscopic camera systems, infrared camera systems, red-green-blue (RGB) camera systems, and combinations of these, for gesture detection and recognition. Additionally, the computing device 1100 may be equipped with accelerometers or gyroscopes that enable detection of motion. The output of the accelerometers or gyroscopes may be provided to the display of the computing device 1100 to render immersive augmented reality or virtual reality.

Some embodiments of computing device 1100 include one or more radio(s) 1124 (or similar wireless communication components). The radio transmits and receives radio or wireless communications. Example computing device 1100 is a wireless terminal adapted to receive communications and media over various wireless networks. Computing device 1100 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. In one example, when referring to “short” and “long” types of connections, such terms are not with reference to the spatial relation between two devices. Instead, in these examples, these terms generally refer to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of code-division multiple access (CDMA), General Packet Radio Service (GPRS), Global System for Mobile Communication (GSM), time-division multiple access (TDMA), and 802.16 protocols.

Referring now to FIG. 12, an example distributed computing environment 1200 is illustratively provided, in which implementations of the present disclosure can be employed. In particular, FIG. 12 shows a high-level architecture of an example cloud computing platform 1210 that can host a technical solution environment or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 1200 that includes cloud computing platform 1210, rack 1220, and node 1230 (for example, computing devices, processing units, or blades) in rack 1220. The technical solution environment can be implemented with cloud computing platform 1210, which runs cloud services across different data centers and geographic regions. Cloud computing platform 1210 can implement the fabric controller 1240 component for provisioning and managing resource allocation, deployment, upgrade, and management of cloud services. Typically, cloud computing platform 1210 acts to store data or run service applications in a distributed manner. Cloud computing platform 1210 in a data center can be configured to host and support operation of endpoints of a particular service application. In one example, the cloud computing platform 1210 is a public cloud, a private cloud, or a dedicated cloud.

Node 1230 can be provisioned with host 1250 (for example, operating system or runtime environment) running a defined software stack on node 1230. Node 1230 can also be configured to perform specialized functionality (for example, computer nodes or storage nodes) within cloud computing platform 1210. Node 1230 is allocated to run one or more portions of a service application of a tenant. A tenant can refer to a customer utilizing resources of cloud computing platform 1210. Service application components of cloud computing platform 1210 that support a particular tenant can be referred to as a multi-tenant infrastructure or tenancy. The terms “service application,” “application,” or “service” are used interchangeably with regards to FIG. 12, and broadly refer to any software, or portions of software, that run on top of, or access storage and computing device locations within, a data center.

When more than one separate service application is being supported by nodes 1230, certain nodes 1230 are partitioned into virtual machines (for example, virtual machine 1252 and virtual machine 1254). Physical machines can also concurrently run separate service applications. The virtual machines or physical machines can be configured as individualized computing environments that are supported by resources 1260 (for example, hardware resources and software resources) in cloud computing platform 1210. It is contemplated that resources can be configured for specific service applications. Further, each service application may be divided into functional portions such that each functional portion is able to run on a separate virtual machine. In cloud computing platform 1210, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 1280 is linked to a service application in cloud computing platform 1210. Client device 1280 may be any type of computing device, such as user device 102 described with reference to FIG. 1 or any other component described herein. The client device 1280 can be configured to issue commands to cloud computing platform 1210. In embodiments, client device 1280 communicates with service applications through a virtual Internet Protocol (IP) and load balancer or other means that direct communication requests to designated endpoints in cloud computing platform 1210. Certain components of cloud computing platform 1210 communicate with each other over a network (not shown), which includes, without limitation, one or more local area networks (LANs) and/or wide area networks (WANs).

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “set” may be employed to refer to an ordered (i.e., sequential) or an unordered (i.e., non-sequential) collection of objects (or elements), such as machines (for example, computer devices), physical and/or logical addresses, graph nodes, graph edges, functionalities, and the like. As used herein, a set may include N elements, where Nis any positive integer. That is, a set may include 1, 2, 3, . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers N). The objects included in other sets may be continuous objects (for example, the set of real numbers R). In some embodiments, “a set of objects” that is not a null set of the objects may be interchangeably referred to as either “one or more objects” or “at least one object,” where the term “object” may stand for any object or element that may be included in a set. Accordingly, the phrases “one or more objects” and “at least one object” may be employed interchangeably to refer to a set of objects that is not the null or empty set of objects. A set of objects that includes at least two of the objects may be referred to as “a plurality of objects.”

As used herein and in one example, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

In one example, an “accelerator” or a “coprocessor” refers to a piece of hardware utilized in a data center and used to run a virtual machine and/or execute a workflow based on an SLA associated with the user account that submits the workflow. In one example, the term “coprocessor” or “accelerator” excludes central processing units (CPUs) and includes components that work in conjunction with the CPUs, such as a graphics processing unit (GPU), a field-programmable gate array (FPGA), or an application-specific integrated circuit (ASIC), among other suitable processing hardware devices. In one example, a “node” refers to a physical computer system with a distinct host internet protocol (IP) address that is running one or more application servers.

In one embodiment, a set of accelerators are controlled to provision, start, maintain, or shut down virtual machines (VMs), such that throttling the accelerators controls the provision and orchestration of virtual machines across workflows for different users. In one example, “VM” refers to a software version of a computer running its own operating system (OS) and programs, which can connect to different networks via any suitable virtualization processes, such as Hyper-V.

In one example, “user account” or “customer account” refers to the account or subscription created by a user or organization with a cloud service provider. In one embodiment, the user account is associated with specific users or organizations and includes specific billing and payment information, access, permissions, resource management consistent with the SLA, security and compliance information, subscription management information, and other information, such as computer resource allocation parameters, associated with a user's interaction within a cloud computing environment.

For purposes of a detailed discussion above, embodiments of the present disclosure are described with reference to a computing device or a distributed computing environment; however, the computing device and distributed computing environment depicted herein are non-limiting examples. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system to coordinate a firmware update and execution of a workflow, the system comprising:
at least one computer processor; and
computer storage media storing computer-useable instructions that, when used by the at least one computer processor, cause the system to perform operations comprising:
accessing a request to perform the firmware update associated with at least one graphics processing unit (GPU) of a node;
based on the request, causing an operating system (OS) driver of the at least one GPU to control a workflow application being hosted or executed on the at least one GPU;
capturing a snapshot of content stored on a high-bandwidth memory (HBM) associated with the GPU;
based on the request, performing the firmware update subsequent to the workflow application being controlled and the snapshot being captured; and
subsequent to completion of the firmware update, causing the OS driver to resume the execution of the workflow application based at least on the snapshot.

2. The system of claim 1, wherein controlling the workflow application comprises pausing the execution of the workflow application.

3. The system of claim 1, wherein controlling the workflow application comprises deleting at least one pending command from the workflow application, wherein the snapshot omits the at least one pending command.

4. The system of claim 1, wherein the at least one GPU corresponds to a primary GPU, wherein the firmware update is accessible by the primary GPU from a firmware orchestrator.

5. The system of claim 4, wherein the primary GPU communicates the firmware update to a neighboring GPU, wherein the operations comprise:
receiving an indication of the completion of the firmware update on the neighboring GPU, and wherein the OS driver causes the execution of the workflow application to resume based on the indication of the completion.

6. The system of claim 1, wherein the at least one GPU comprises a communication interface, wherein the at least one GPU communicates with the OS driver via the communication interface.

7. The system of claim 6, wherein the request to perform the firmware update is received from a firmware orchestrator, wherein the node comprises another GPU that does not have the communication interface, wherein the other GPU not having the communication interface is unable to receive the request to perform the firmware update from the firmware orchestrator.

8. The system of claim 6, wherein the request to perform the firmware update is received from a firmware orchestrator via a baseboard management controller (BMC) of the node, wherein the request is accessed within the node by the at least one GPU from the BMC.

9. The system of claim 1, wherein the snapshot comprises at least one of metadata associated with the execution of the workflow application or contextual data associated with the execution of the workflow application.

10. The system of claim 1, wherein causing the OS driver to resume the execution of the workflow application based at least on the snapshot comprises:
communicating to the OS driver an indication that an aspect of the firmware update has been completed on the at least one GPU; and
restoring the HBM with content from the snapshot, wherein the workflow application resumes the execution based on the content from the snapshot.

11. A computer-implemented method, comprising:
transmitting, via an operating system (OS) driver of at least one graphics processing unit (GPU) of a node, a request to perform a firmware update on the at least one GPU;
causing the at least one GPU to capture a snapshot of a high-bandwidth memory (HBM) of the at least one GPU based on the request;
controlling a workflow application being hosted or executed by the at least one GPU until completion of an aspect of the firmware update;
receiving an indication of the completion of the aspect of the firmware update; and
resuming execution of the workflow application subsequent to the completion of the aspect of the firmware update.

12. The computer-implemented method of claim 11, further comprising:
accessing a respective tagging for a plurality of GPUs; and
determining, from the plurality of GPUs, which GPU of the plurality of GPUs has a respective tagging indicative of a primary GPU tagging, and wherein the request to perform the firmware update is transmitted to the GPU having the respective tagging indicative of the primary GPU tagging for communication to neighboring GPUs not having the respective tagging.

13. The computer-implemented method of claim 11, wherein the at least one GPU comprises a communication interface communicatively coupled to the OS driver, wherein the OS driver does not communicate the request to another GPU not having the communication interface.

14. The computer-implemented method of claim 11, further comprising receiving, from a firmware orchestrator, software associated with the firmware update, wherein the request to perform the firmware update is transmitted, via the OS driver to a baseboard management controller (BMC) of the node.

15. The computer-implemented method of claim 11, wherein causing the at least one GPU to capture a snapshot comprises instructing the workflow application to pause and store on the HBM content associated with the workflow at a time of pausing.

16. The computer-implemented method of claim 11, wherein controlling the workflow application comprises at least one of: pausing the execution of the workflow application or deleting at least one pending command from the workflow application.

17. One or more computer storage media having computer-executable instructions embodied thereon that, when executed by one or more processors cause a computing system to perform operations comprising:
accessing a request to perform a firmware update associated with at least one graphics processing unit (GPU) of a node;
based on the request, causing an operating system (OS) driver associated with the at least one GPU to pause execution of a workflow application being hosted or running on the at least one GPU;
capturing a snapshot of content stored at a time of pausing the execution of the workflow application and on a memory device associated with the GPU;
based on the request, performing the firmware update subsequent to the workflow application being paused and the snapshot being captured; and
subsequent to completion of an aspect of the firmware update, causing the OS driver to resume the execution of the workflow application based at least on the snapshot.

18. The one or more computer storage media of claim 17, wherein pausing the execution of the workflow application comprises deleting at least one pending command from the workflow application, wherein the snapshot does not include the at least one pending command.

19. The one or more computer storage media of claim 17, wherein the at least one GPU corresponds to a primary GPU, wherein the firmware update is accessible to the primary GPU from a firmware orchestrator.

20. The one or more computer storage media of claim 19, wherein the primary GPU communicates the firmware update to a neighboring GPU, wherein the operations comprise receiving an indication of the completion of the aspect of the firmware update on the neighboring GPU, and wherein the OS driver causes the execution of the workflow application to resume based on the indication of the completion.
